(19) United States
(12) Patent Application Publication
(10) Pub. No.: US 2024/0139862 A1
(43) Pub. Date: May 2, 2024

(54) SYSTEM AND METHOD FOR REMOVING PAVEMENT MARKINGS

(71) Applicant: UNIVERSITY OF NORTH TEXAS, DENTON, TX (US)

(72) Inventor: Maurizio Manzo, Denton, TX (US)

(21) Appl. No.: 18/496,035

(22) Filed: Oct. 27, 2023

Related U.S. Application Data
(60) Provisional application No. 63/421,069, filed on Oct. 31, 2022.

(51) Int. Cl. B23K 26/042; B23K 26/00; B23K 26/362

(52) U.S. Cl. CPC B23K 26/042; B23K 26/0006; B23K 26/362; B23K 2103/30

(57) ABSTRACT

The present disclosure provides for systems and methods for removing markings from pavement. In general, the present disclosure provides for methods of using thermal ablation for effectively removing pavement stripe markings without causing excessive damage to the pavement surface.

### CLAIM OF PRIORITY TO RELATED APPLICATION

This application claims priority to co-pending U.S. provisional application entitled “SYSTEM AND METHOD FOR REMOVING PAVEMENT MARKINGS” having Ser. No. 63/421,069, filed on Oct. 31, 2022, which is entirely incorporated herein by reference.

### BACKGROUND

The removal of pavement markings is required when traffic patterns change or when road expansion occurs. Incomplete removal of pavement markings can lead to unsafe driving conditions and even fatal accidents. Many techniques, such as water-blasting, soda blasting, dry ice blasting, grinding, hydro-blasting, shot blasting, and sandblasting all cause damage to road surfaces and leave scarring or ghost stripes. These ghost stripes can confuse drivers, especially at night or under rain conditions. Disclosed are several embodiments of pavement-marking removal systems and methods using thermal ablation.

### SUMMARY

Embodiments of the present disclosure provide for systems and methods for removing markings from pavement. In general, embodiments of the present disclosure provide for methods of using thermal ablation for effectively removing pavement stripe markings without causing excessive damage to the pavement surface.

The present disclosure provides for a method for removing pavement markings, comprising: aligning a vehicle with a type of pavement marking on a type of pavement, the vehicle having a laser system; aiming the laser system at the type of pavement marking; detecting the type of pavement marking using a sensor; detecting the type of pavement using the sensor; setting a plurality of laser parameters based at least in part on detection of the type of pavement marking and detection of the type of pavement; activating the laser system to produce a laser beam; and passing the laser beam over the type of pavement marking in a scan direction.

The present disclosure provides for a method, comprising: receiving, by a laser control application, a vehicle aligned indication that a vehicle has been aligned with a type of pavement marking on a type of pavement; sending, by the laser control application, a request to a laser system to aim a laser beam at the type of pavement marking; receiving, by the laser control application, a pavement type indication from a sensor; receiving, by the laser control application, a pavement marking type indication from the sensor; determining, by the laser control application, a plurality of laser parameters based at least in part on the pavement type indication and the pavement marking type indication; sending, by the laser control application, the plurality of laser parameters to the laser system; sending, by the laser control application, an initiation request to the laser system; and sending, by the laser control application, a movement request to the laser system to pass the laser beam over the type of pavement marking in a scan direction.

The present disclosure provides for a system configured to remove pavement markings, comprising: at least one laser comprising: a laser head which produces a laser beam, wherein system is configured to direct the laser beam at the pavement marking, a lens through which the laser beam passes, and a laser box containing the laser head and the lens; a water-cooler chiller connected to the laser box configured to regulate the temperature of the laser; optionally, a fume extractor in communication with an area adjacent the pavement marking to remove fumes upon passing the laser over the pavement markings; a power source connected to the laser; a sensor, wherein the sensor is configured to capture an image of the pavement marking; a computing device comprising a processor and a memory, wherein the computing device is in communication with the laser, the water cooler, the power source, and the sensor; and machine-readable instructions stored in the memory that, when executed by the processor, cause the computing device to perform methods as described above and herein.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals, designate corresponding parts throughout the several views.

FIG. 1.1 is a photograph of a laser scan system comprising of a concrete sample, a pressured air knife, a laser scan head, a laser, a water cooler, and a fume extractor according to various embodiments of the present disclosure.

FIG. 1.2 is a photograph displaying the progression of the laser stripe removal process, including a photograph of an original stripe prior to any ablation, a stripe containing three different ablated areas, and a stripe with eight different ablated areas according to various embodiments of the present disclosure.

FIG. 1.3 is a photograph detailing the results of a grayscale comparison (including respective RMSE values errors as detailed in Table 1.1) between an area of a stripe removed via the laser removal system and the original stripe according to various embodiments of the present disclosure.

FIG. 1.4 is a photograph illustrating the removal of a paint stripe on concrete according to various embodiments of the present disclosure.

FIG. 2.1 is a photograph of concrete samples, including three types of concrete pavement stripes via thermos by truck, hot tape, and paint according to various embodiments of the present disclosure.

FIG. 2.2 is a photograph of a IPG Laser GmbH (Model: YLP-OLRC) comprising of a sample, a pressured air knife, a laser scan head, a laser, a water cooler, and a fume extractor according to various embodiments of the present disclosure.

FIG. 2.3 is a photograph displaying the progression of the stripe laser removal process, including an image showing the sample with the original stripe prior to any use of the laser removal process, a stripe with three different rectangles removed areas, and a stripe with eight different rectangles removed areas according to various embodiments of the present disclosure.

FIG. 2.4 is a photograph of various camera angles (90 degrees, 45 degrees, and 20 degrees) of the results of the laser stripe removal process according to various embodiments of the present disclosure.

FIG. 2.5 is a photograph of a grayscale comparison between a removed area of a stripe and the original stripe according to various embodiments of the present disclosure.

FIG. 2.6 is a photograph detailing the results of a grayscale comparison between a removed area of a stripe and the original stripe according to various embodiments of the present disclosure.

FIG. 2.7 is a chart detailing the results of a scan time linear regression analysis according to various embodiments of the present disclosure.

FIG. 2.8 is a chart detailing the results of a grayscale error linear regression analysis according to various embodiments of the present disclosure.

FIG. 2.9 is a photograph of samples of thermoplastic stripes taken under sunlight according to various embodiments of the present disclosure.

FIG. 2.10 is a photograph of samples of thermoplastic stripes taken at night according to various embodiments of the present disclosure.

FIG. 2.11 is a photograph of thermoplastic stripes under both sunlight and at night, both of which are accompanied by a chart detailing the numerical value of the RMSE errors of each thermoplastic stripe sample according to various embodiments of the present disclosure.

FIG. 2.12 is a chart detailing a grayscale error (RMSE) comparison between photos of thermoplastic stripes taken in doors, under sunlight, and at night according to various embodiments of the present disclosure.

FIG. 2.13 is a photograph of a hot tape stripe on concrete removed by laser according to various embodiments of the present disclosure.

FIG. 2.14 is a photograph of samples of hot tape stripes taken under sunlight according to various embodiments of the present disclosure.

FIG. 2.15 is a photograph of samples of hot tape stripes taken at night according to various embodiments of the present disclosure.

FIG. 2.16 is a chart detailing a grayscale error (RMSE) comparison between photos of hot tape stripes taken in doors, under sunlight, and at night according to various embodiments of the present disclosure.

FIG. 2.17 is a photograph of a paint stripe removed via laser according to various embodiments of the present disclosure.

FIG. 2.18 is a photograph of paint stripes taken under sunlight according to various embodiments of the present disclosure.

FIG. 2.19 is a photograph of paint stripes taken at night according to various embodiments of the present disclosure.

FIG. 2.20 is a chart detailing a grayscale error (RMSE) comparison between photos of paint stripes taken in doors, under sunlight, and at night according to various embodiments of the present disclosure.

FIG. 2.21 is a photograph of the removal of paint stripe in a 1×1 square according to various embodiments of the present disclosure.

FIG. 2.22 is a photograph of an asphalt sample with a paint stripe removed by laser in both a 1×1 square area and a 1×4 rectangle area according to various embodiments of the present disclosure.

FIG. 2.23 is a photograph of the laser removal process of paint stripe of 2.5″×2.5″ square from asphalt via multiple scans according to various embodiments of the present disclosure.

FIG. 3.1 is a drawing of a vehicle with the laser removal system according to various embodiments of the present disclosure.

FIG. 3.2 is a drawing of the laser removal system according to various embodiments of the present disclosure.

FIG. 3.3 is a drawing of a network environment that can include a sensor, a laser system, a computing environment, and a client device according to various embodiments of the present disclosure.

FIG. 3.4 is a flowchart detailing the functionality of the laser control application system according to various embodiments of the present disclosure.

FIG. 3.5 is a flowchart detailing an example of the many different types of functional arrangements that can be employed to implement the operation of the depicted portion of the laser control application according to various embodiments of the present disclosure.

FIG. 3.6 is a sequence diagram that illustrates the interactions between the sensor, the laser control application, the laser system, and the client application according to various embodiments of the present disclosure.

### DISCUSSION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the materials disclosed and claimed herein. Efforts have been made to ensure accuracy with respect to numbers (e.g., amounts, temperature, etc.), but some errors and deviations should be accounted for.

It will be understood that when an element is referred to as being “connected to” or “coupled to” or “electrically coupled to” another element, it can be directly connected or coupled, or intervening elements may be present.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and systems encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

### General Discussion

In accordance with the purpose(s) of the present disclosure, as embodied and broadly described herein, embodiments of the present disclosure, in some aspects, relate to systems and methods for removing markings from pavement. In general, embodiments of the present disclosure provide for methods of using thermal ablation for effectively removing pavement stripe markings without causing excessive damage to the pavement surface.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

In general, the present disclosure provides for a method for removing the pavement markings. The method can include aligning a vehicle with a type of pavement marking on a type of pavement, where the vehicle includes a laser system. The type of pavement marking can be detected using a sensor. The type of pavement can be detected using the sensor. The laser system can be aimed a laser beam at the type of pavement marking. Settings of a plurality of laser parameters can be set based at least in part on detection of the type of pavement marking and detection of the type of pavement. The laser system can be activated to produce a laser beam that is passed (e.g., directed at) over the type of pavement marking in a scan direction. The pavement marking is removed by the laser beam.

In an aspect, the present disclosure provides for removing the pavement markings. The method includes receiving, by a laser control application, a vehicle aligned indication that a vehicle has been aligned with a type of pavement marking on a type of pavement. Then the laser control application sends a request to a laser system to aim a laser beam at the type of pavement marking. The laser control application receives a pavement type indication from a sensor. The laser control application receives a pavement marking type indication from the sensor. The laser control application determine a plurality of laser parameters based at least in part on the pavement type indication and the pavement marking type indication. The laser control application sends the plurality of laser parameters to the laser system. The laser control application sends an initiation request to the laser system. The laser control application sends a movement request to the laser system to pass the laser beam over the type of pavement marking in a scan direction.

In another aspect, the present disclosure provides for a system configured to remove the pavement markings. The system includes a laser, a water-cooler chiller, a power source, a sensor, and computing device (optionally a fume extractor). The laser includes at least one laser including: a laser head which produces a laser beam. The system is configured to direct the laser beam at the pavement marking, a lens through which the laser beam passes, and a laser box containing the laser head and the lens. The water-cooler chiller is connected to the laser box configured to regulate the temperature of the laser. A fume extractor in communication with an area adjacent the pavement marking to remove fumes upon passing the laser over the pavement markings. A power source connected to the laser. A sensor is configured to capture an image of the pavement marking. A computing device including a processor and a memory, where the computing device is in communication with the laser, the water cooler, the power source, and the sensor. The computing system can communicate with the various components to achieve removing the pavement markings. The machine-readable instructions stored in the memory that, when executed by the processor, cause the computing device to perform methods as described above and herein and achieve the desired results for the various components.

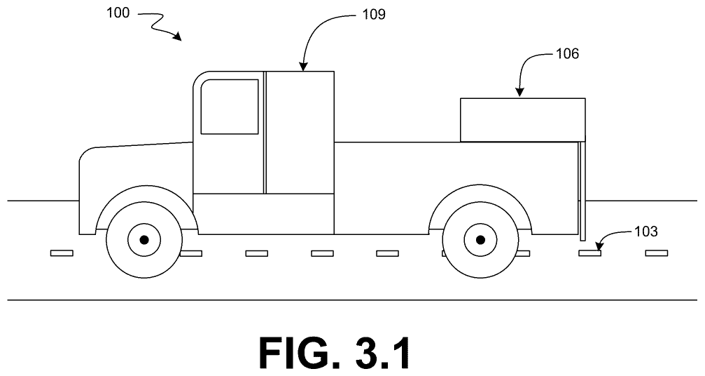

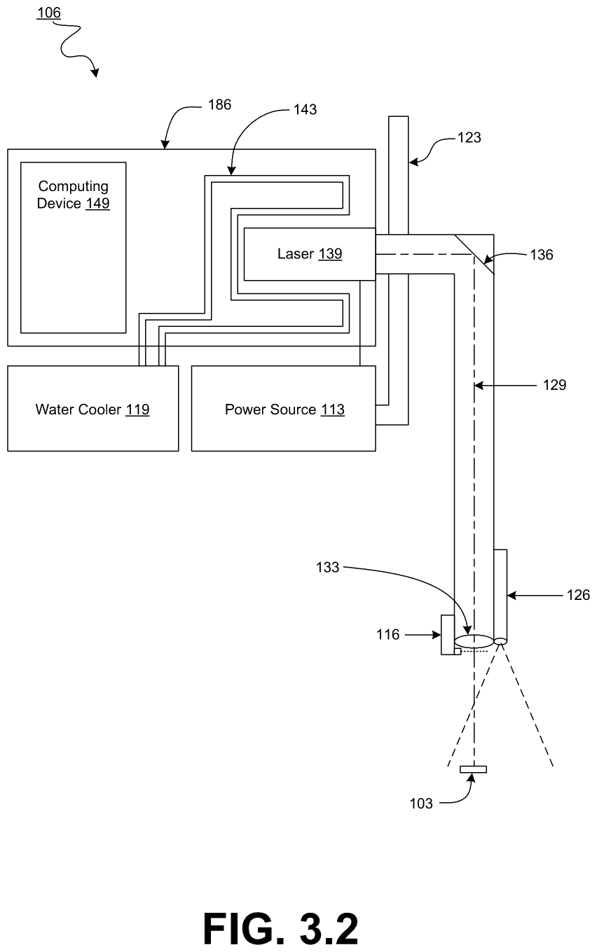

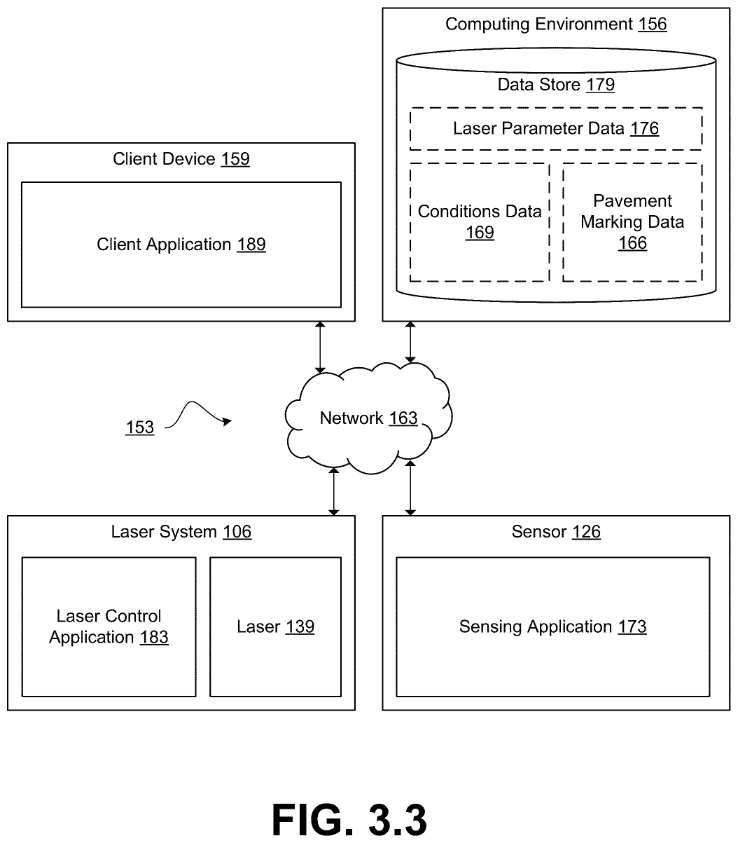

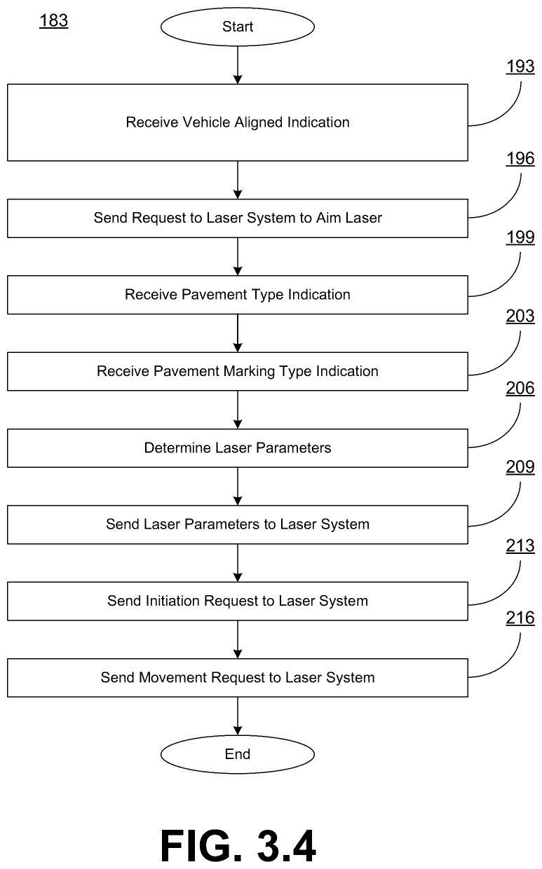

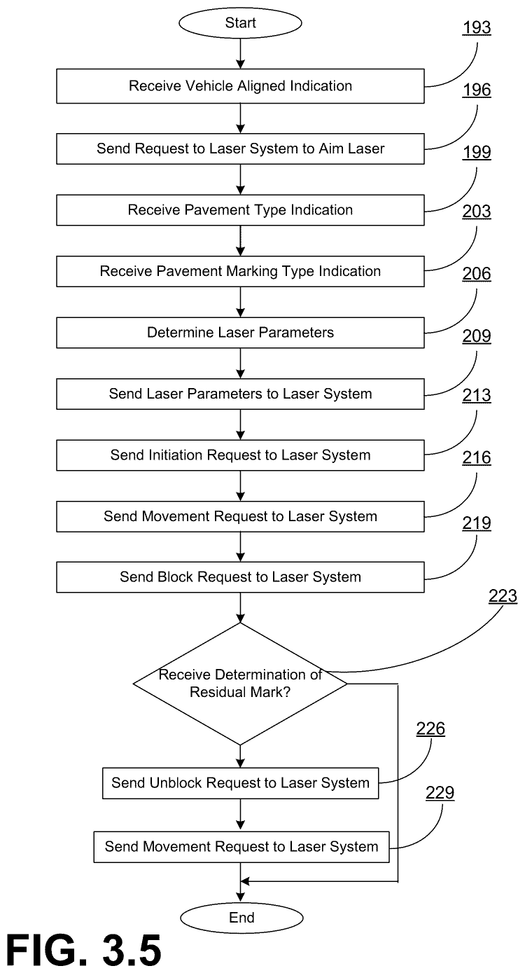

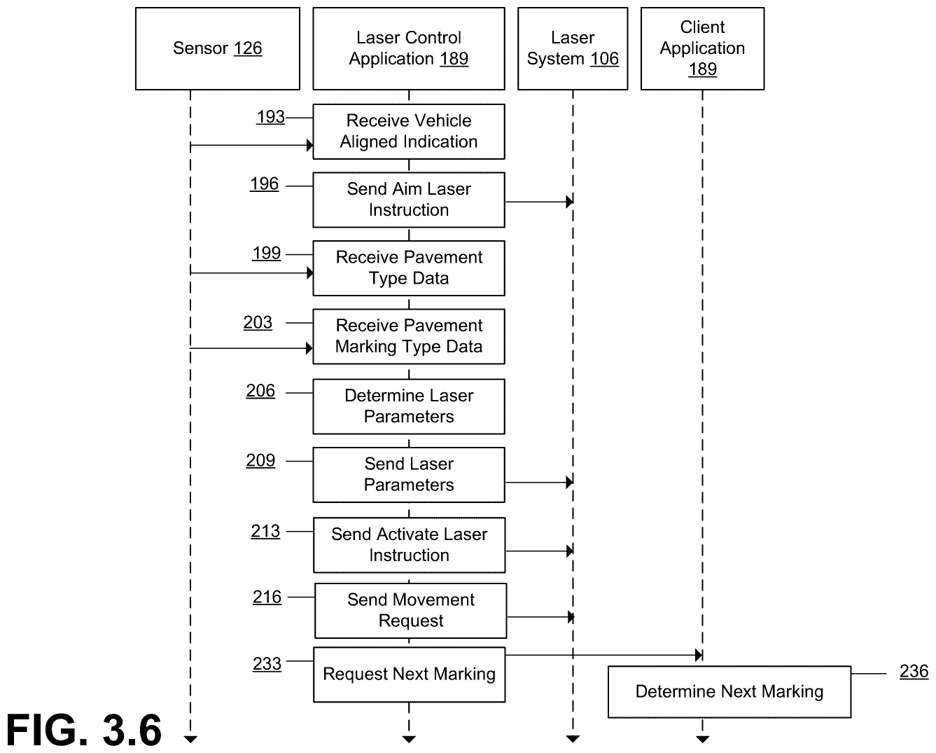

Now having described aspects of the present disclosure generally, additional detail are now provided. The present disclosure includes a thermal ablation system 100 (e.g., mounted on a vehicle) for removing pavement markings 103. As shown in FIGS. 3.1 and 3.2, the system 100 may include a laser system 106 (e.g., pulsed fiber laser system 106) attached to a vehicle 109, a power source 113, optionally a pressurized air knife 116, a water cooler 119, optionally a fume extractor 123, and a camera or other sensor 126. The laser system 106 and the vehicle 109 can be in communication so that speed, alignment with pavement marking 103, timing of the laser pulse, and the like can be coordinated to achieve the desired results of the present disclosure. The communication between and among the vehicle 109 and the fiber system 106 and it's components can provide for automatic adjustments to one or more variable (e.g., speed, steering, timing of laser pulse, and the like) and/or communicated so that the adjustments can be manually made. In alternative embodiments, the system 100 may be mounted on a vehicle 109 directly or on a trailer pulled behind the vehicle 109. While the vehicle 109 is depicted as a pick-up truck in FIG. 3.1, the vehicle 109 may comprise any type of vehicle where the pick-up truck is presented as an example. To this end, the vehicle 109 may comprise other vehicles falling into various categories such as passenger vehicles, off-road vehicles, robotic vehicles, and the like, in which such vehicles include a laser system 106 shown in FIG. 3.1.

In some embodiments, dampening components may be used around the laser system 106 to lessen vibrations caused by the system 100. In some embodiments, the power source 113 is a generator or directly connected to the vehicle 109 to provide power. In some embodiments, the laser system 106 includes a servo motor to control the movement of the laser beam 129.

The laser beam 129 can be focused through a lens 133 (or a lens system including a plurality of lenses). In some embodiments, one or more mirrors 136 may be used to redirect the laser beam 129 as it exits the laser 139. The lens 133 may be optionally protected from debris by the pressurized air knife 116 or other mechanism to shield it from debris. The water cooler 119 can use a series of water channels 143 to prevent the mechanisms of the laser 139 from overheating. The water cooler 119 can adjusted accordingly in response to the temperature of the various mechanisms of the laser 139, atmospheric temperature and humidity, activation of the laser 139, and the like. The fume extractor 123 collects any fumes that may result from the ablation process and can be attached to the system or vehicle depending upon the embodiment. The fume extractor 123 can be positioned relative to the ablation process to collect fumes and/or debris.

In an aspect, the sensor 126 may guide alignment of the laser 139 with a pavement marking 103 as well as detect the type of pavement and the type of pavement marking 103. The sensor 103 can provide information that can be used by the driver of the vehicle 109 to make appropriate adjustments or the adjustments can be automatically made (e.g., with a driverless vehicle or a driver controlled (with limited control during use to remove pavement markings) vehicle). The sensor 126 can be positioned adjacent the laser system 106 or can be positions elsewhere on the system 126 so that it can detect the pavement marking 103. The sensor 126 can be in communication with the computing device 149 so that the computing device 149 can instruct the laser 139 to generate a laser beam and, if needed, with the vehicle 109.

In an aspect, the air pressure supply to the pressurized air knife 116 may be adjusted depending on the distance from the lens 133 to the marking 103, where the pressure is increased as the distance is decreased. In an aspect, the pressurized air knife 116 can be attached and positioned on the laser system 106, adjacent the exit of the laser beam and near the lens 133 and can be activated in accordance with the initiation of the laser beam being produced and impacted the pavement marking 103. When the lens 133 is far away from the pavement marking 103, the pressurized air knife 116 may not be needed.

The various components of the system 100 can be in communication (e.g., direct or WI-FI® or BLUETOOTH®, electrically or other otherwise) with one another via wires and other components so that the system 100 can operate as described herein. For example, a computing device 149 can be interfaced (e.g., directly or indirectly) with all of the other components (e.g., laser 139, water cooler 119, power source 113, vehicle 109, air knife 116, and the like) to ensure proper operation (e.g., timing of the laser, timing of the air knife, power of the laser, cooling parameters of the water cooler, power source, timing of the sensor, fume extractor, speed of the vehicle, alignment of the laser with the pavement markings, and the like). Methods of the present disclosure can be implemented using the system 100 and the methods further describe the physical and electronic connections and interplay between and among the various components of the system 100.

The power source 113 should produce a clean, stable electrical output so that the laser may operate effectively. In some embodiments, the power source 113 is a Honda EU7000ISNAN 7000-Watt 120/240-Volt Inverter Generator. In other embodiments, the power source 113 is a 3-phase generator. In still other embodiments, the power source is from the vehicle 109.

The system 100 can be arranged (e.g., physical and electronic connections) to perform a method of ablating a pavement marking 103 by first aligning a laser system 106 on a vehicle 109 with a pavement marking 103. The various components of the system 100 act in concert to achieve the proper alignment with the pavement marking 103 and the proper speed of the vehicle 109. The laser system 106 can be aimed at the marking 103. In general, the vehicle 109 is aligned with the pavement marking 103, but the laser system 106 can also be adjusted to ensure the laser impacts the pavement marking 103. The type of pavement and the type of marking 103 can be detected using a sensor 126. One or more of a plurality of laser parameters 146 can be set based at least in part on the type of pavement and the type of marking 103 as well as the speed of the vehicle 109 and the environmental conditions (e.g., rain, snow, temperature, humidity and the like). Subsequently, the laser system 106 is activated to produce a laser beam 129. The laser beam 129 can be passed over the marking 103 in a scan direction to ablate the marking 103. Additionally, the method may also include changing the scan direction to a second scan direction and passing the laser beam 129 over the pavement marking 103 in the second scan direction to enhance ablation of the marking 103.

The plurality of laser parameters 146 may include at least one of a laser power, a laser wavelength, a laser fluence, a pulse frequency, a pulse width, a velocity, and a fill pitch. The parameters 146 can vary depending on the distance between the laser lens 133 and the pavement marking 103, the angle of the laser beam 129, the scanning speed of the laser 106, the type and color of the marking 103, the type of pavement, the speed of the vehicle, as well as other conditions such as the temperature of the pavement and moisture on the pavement. Additionally, the distance of the laser lens 133 from the pavement may vary depending on the length and width of the pavement marking 103.

In further embodiments, the method may include the steps of blocking the laser beam 129 from exiting the laser system 106; scanning for and determining whether a residual mark is left on the pavement; and if so, passing the laser beam 129 over the residual mark. If the pavement is free of residual marks, the system can either keep blocking the laser beam 129 and proceed to the next mark 103, or it can shut the laser system 106 off.

In some embodiments, glass beads can be removed from the pavement marking 103 before the system ablates the marking. Removal of the glass beads may be accomplished by flying or other mechanical means. In some embodiments, the sensor 126 rechecks the type of marking 103 and type of pavement at each new marking 103, and adjusts the laser parameters 146 accordingly.

Additionally, the laser system 106 may include a computing device 149 to control the laser system 106, communicate with the vehicle 109, and communicate with a GPS system or satellite. With reference to FIG. 3.3, shown is a network environment 153 according to various embodiments. The network environment 153 can include a sensor 126, a laser system 106, a computing environment 156, and in some embodiments, a client device 159, which can be in data communication with each other via a network 163. The network can be in communication with the vehicle 109, GPS system and the like.

The network 163 can include wide area networks (WANs), local area networks (LANs), personal area networks (PANs), or a combination thereof. These networks can include wired or wireless components or a combination thereof. Wired networks can include Ethernet networks, cable networks, fiber-optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 163 can also include a combination of two or more networks 163. Examples of networks 163 can include the Internet, intranets, extranets, virtual private networks (VPNs), and similar networks. In at least some embodiments, the sensor 126 and/or laser system 106 can be connected to the client device 159 over a BLUETOOTH® network. In at least another embodiment, the sensor 126 and/or the laser system 106 can be connected to the client device 159 over a WI-FI® network.

The laser system 106 can be one or more computing devices 149 that can be coupled (e.g., electrically coupled) to the network 163. The laser system 106 can include a processor-based system such as a computer system. Such a computer system can be embodied in the form of a mobile computing device (e.g., personal digital assistants, cellular telephones, smartphones, web pads, tablet computer systems, music players, portable game consoles, electronic book readers, and similar devices), a videogame console, or other devices with like capability. In many embodiments, the sensor 126 can be a specialized computing device made specifically for collecting pavement marking data 166 and conditions data 169.

The sensor 126 can be a device capable of capturing images. For instance, the sensor 126 can be a camcorder (digital or analog), a digital camera capable of capturing video, a mobile computing device capable of capturing video (e.g., personal digital assistants, cellular telephones, smartphones, web pads, tablet computer systems, music players, portable game consoles, electronic book readers, and similar devices), a videogame console, or other like devices capable of capturing photographs or video. In at least one embodiment, the sensor 126 can include one or more computing devices that include a processor, a memory, and/or a network interface. The sensor 126 can produce an image that the driver of the vehicle 109 can view and adjust the vehicle 109 and/or laser system 106 as needed.

The sensor 126 can be configured to execute various applications such as a sensing application 173, or other applications. The sensor 126 can also be configured to execute applications beyond the sensing application 173, if necessary. The sensing application 173 can be configured to collect, obtain, and/or receive data 166 corresponding to the pavement type, marking type, and size and color of the marking 103. The sensing application 173 can be configured to collect, obtain, and/or receive data 169 corresponding to the conditions of the pavement and weather. In at least one embodiment, the sensing application 173 can transmit the conditions data 169 and the pavement marking data 166 over the network 163 to the computing environment 156. The computing environment 156 can combine the collected, obtained, and/or received data 166 about the pavement marking 103 and data about the conditions 169 to generate laser parameters data 176 that can be sent to other devices and/or other applications. In at least another embodiment, the sensing application 173 can transmit the conditions data 169 and the pavement marking data 166 over the network 163 to the client device 159. In at least one embodiment, the sensing application 173 can send the conditions data 169 and pavement marking data 166 to the client device 149 in real-time as the conditions data 169 and pavement marking data 166 is obtained. In another embodiment, the computing environment 156 can transmit the laser parameter data 176 over the network 163 to the client device 159. In at least one embodiment, the computing environment 156 can send the laser parameter data 176 to the client device 149 in real-time as the laser parameter data 176 is obtained.

The computing environment 156 can include one or more computing devices 149 that include a processor, a memory, and/or a network interface. For example, the computing devices 149 can be configured to perform computations on behalf of other computing devices or applications. As another example, such computing devices 149 can host and/or provide content to other computing devices 149 in response to requests for content. Moreover, the computing environment 156 can employ a plurality of computing devices 149 that can be arranged in one or more server banks or computer banks or other arrangements. Such computing devices 149 can be located in a single installation or can be distributed among many different geographical locations. For example, the computing environment 156 can include a plurality of computing devices 149 that together can include a hosted computing resource, a grid computing resource, or any other distributed computing arrangement. In some cases, the computing environment 156 can correspond to an elastic computing resource where the allotted capacity of processing, network, storage, or other computing-related resources can vary over time.

Alternatively, the computing environment 156 can be one or more computing devices 149 that can be coupled (e.g., electrically coupled) to the network 163. The computing environment 156 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), a videogame console, or other devices with like capability. The computing environment 156 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the computing environment 156 or can be connected to the computing environment 156 through a wired or wireless connection.

In many embodiments, the computing environment 156 can have a data store 179. The data store 179 can be representative of a plurality of data stores 179, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store 179. Various data can be stored in the data store 179 that is accessible to the computing environment 156. The data stored in the data store 179 is associated with the operation of the various applications or functional entities described herein. This data can include laser parameter data 176, conditions data 169, pavement marking data 166, and potentially other data.

The laser system 106 can include one or more computing devices 149 that can be coupled (e.g., electrically coupled) to the network 163. The laser system 106 can include a processor-based system, such as a computer system. In at least one embodiment, the laser system 106 can be embodied in the form of a mobile computing device (e.g., personal digital assistants, cellular telephones, smartphones, web pads, tablet computer systems, music players, portable game consoles, electronic book readers, and similar devices), a videogame console, or other devices with at least a processor, a network device to connect to a network 163, and/or one or more devices capable of operating a laser 139.

The laser system 106 can be configured to execute various applications, such as a laser control application 183 or other applications. The laser system 106 can also be configured to execute applications beyond the laser control application 183, if necessary. The laser control application 183 can be configured to receive signals from the network 163 indicating that the laser 139 needs to be started or stopped, the laser parameters 146 need to be adjusted, or the laser beam 129 needs to be blocked. In some embodiments, the laser control application 183 can be arranged to perform a method of ablating a pavement marking 103 by first receiving an indication that a vehicle 109 has been aligned with a marking 103 on the pavement. The laser control application 183 may then send a request to a laser system 106 to aim a laser beam 129 at the pavement marking 103. The pavement type and the type of marking 103 can be detected by a sensor 126 which then reports these detections to the laser control application 183. The laser control application 183 may then determine a plurality of laser parameters 146, based at least in part on the pavement type and the marking 103 type, and send the plurality of laser parameters 146 to the laser system 106. Then laser control application 183 may send an initiation request to the laser system 106 to activate the laser beam 129. Additionally, the laser control application 183 may send one or more movement requests to the laser system 106 to pass the laser beam 129 over the pavement marking 103. The method may also include sending a request to the laser system 106 to change the scan direction and to pass the laser beam 129 over the pavement marking 103 again. In some embodiments, the laser control application 183 may send a request to the laser system 106 to block the laser beam 129; receive from the sensor 126 a determination of whether there is a residual mark on the pavement; and if so, send a request to the laser system 106 to unblock the laser beam 129 and to pass the laser beam 129 over the residual mark. If the sensor 126 determines there is no residual mark, the laser control application 183 can send a request to a user to find the next pavement marking 103 or to shut off.

In some embodiments, the laser control application 183 may communicate with the sensor 126 to determine what type of marking 103 is next and adjust the laser parameters 146 according to the new type of marking 103, before passing the laser 139 over the new type of marking 103.

The client device 159 is representative of a plurality of client devices 159 that can be coupled (e.g., electrically coupled) to the network 163. The client device 159 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 159 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 159 or can be connected to the client device 159 through a wired or wireless connection.

The client device 159 can be configured to execute various applications such as a client application 189, or other applications. The client device 159 can be configured to execute applications beyond the client application 189, such as email applications, social networking applications, word processors, spreadsheets, or other applications.

In some embodiments, the client device 159 can execute the client application 189. The client application 189 can be used to execute the laser control application 183 and the sensing application 173 remotely.

Referring next to FIG. 3.4, shown is a flowchart that provides one example of the operation of the laser control application 183. The flowchart of FIG. 3.4 provides merely an example of the many different types of functional arrangements that can be employed to implement the operation of the depicted portion of the laser control application 183. Alternatively, the flowchart of FIG. 3.4 could be viewed as depicting a method implemented by the computing environment 156.

Beginning with block 193, the laser control application 183 can receive a vehicle aligned indication. The laser control application 183 can receive such a vehicle aligned indication from the sensor 126 or from a user through the client application 189.

At block 196, the laser control application 183 can send a request to the laser system 106 to aim the laser beam 129 at the pavement marking 103.

At block 199, the laser control application 183 can receive a pavement type indication. At block 203, the laser control application 183 can receive a pavement marking type indication. In alternative embodiments, the laser control application 183 can receive the pavement marking data 166 and the conditions data 169 from the sensor 126. The laser control application 183 can then determine the laser parameters 146 as shown in block 206.

In further embodiments, the computing environment 156 can determine the laser parameter data 176, and the laser control application 183 can receive the laser parameter data 176 from the computing environment 156. After the laser control application 183 has received or determined the laser parameters 146, the laser control application 183 sends the laser parameters 146 to the laser system 106 to set the parameters 146 for the laser 139, as shown in block 209.

In block 213, the laser control application 183 can send an initiation request to the laser system 106 to activate the laser 139. In block 216, the laser control application 183 can send a movement request to the laser system 106 to move the laser 139 over the pavement marking 103.

In FIG. 3.5, shown is a flowchart that provides another example of the operation of the laser control application 183. The flowchart of FIG. 3.5 provides merely an example of the many different types of functional arrangements that can be employed to implement the operation of the depicted portion of the laser control application 183. Alternatively, the flowchart of FIG. 3.5 could be viewed as depicting a method implemented by the computing environment 156.

Blocks 193 through 216 are the same as those shown in the flowchart of FIG. 3.4. New blocks include 219, where the laser control application 183 can send a block request to the laser system 106 to block the laser beam 129 from exiting the lens 133.

At block 223, the laser control application 183 communicates with the sensor 126 to determine if there is a residual mark on the pavement. The laser control application 183 may receive a determination of a residual mark from the sensor 126. If the laser control application 183 receives such a determination, the laser control application 183 will send an unblock request to the laser system 106 to unblock the laser beam 129 from exiting the lens 133. At block 229, the laser control application 183 will send a movement request to the laser system 106 to move the laser 139 over the residual mark.

If, at block 223, the laser control application 183 does not receive a residual mark determination from the sensor 126, the laser control application 183 will end the process.

Referring next to FIG. 3.6, shown is a sequence diagram that illustrates the interactions between the sensor 126, the laser control application 183, the laser system 106, and the client application 189. The sequence diagram of FIG. 3.6 provides merely an example of the many different types of functional arrangements that can be employed to implement the operation of the depicted portion between the sensor 126, the laser control application 183, the laser system 106, and the client application 189. As an alternative, the sequence diagram of FIG. 3.6 can be viewed as depicting an example of elements of a method implemented in the network environment 153.

To begin, the laser control application 183 can receive a vehicle aligned indication from the sensor 126, as previously described in the discussion of block 193 of FIG. 3.4. The laser control application 183 can send an aim laser instruction to the laser system 106 as previously described in the discussion of block 196 of FIG. 3.4. The laser control application 183 can receive pavement type data and pavement marking type data from the sensor 126 as previously described in the discussion of blocks 199 and 203 of FIG. 3.4. The laser control application 183 can determine the laser parameters 146 as previously described in the discussion of block 206 of FIG. 3.4. The laser control application 183 can send the laser parameters 146 to the laser system 106 as previously described in the discussion of block 209 of FIG. 3.4. The laser control application 183 can send an activate laser instruction and a movement request to the laser system 106 as previously described in the discussion of blocks 213 and 213 of FIG. 3.4. Finally, as shown in blocks 233 and 236 of FIG. 3.6, the laser control application 183 can send a request to the client application to determine if there is a next marking.

Additionally, a non-transitory, computer-readable medium, could be configured that includes machine-readable instructions that, when executed by a processor, cause a computing device 149 to perform the above-described methods.

In other embodiments, the system comprises a laser system 106, a power source 113 connected to the laser system 106, a sensor 126, and a computing device 149 with machine-readable instructions stored in the memory. The laser system 106 may include a laser 139 which produces a laser beam 129, a lens 133 through which the laser beam 129 passes, and a laser box 186 containing the laser 139 and the lens 133. In some embodiments, there is at least one mirror 136 inside the laser box 186 redirecting the laser beam 129 from the laser 139 through the lens 133. In some embodiments, the laser 139 is a pulsed Ytterbium fiber laser with the following specifications: 200 Watts Average Power, 10 mJ pulse energy, M2<14 (typ 12), 30-240 ns pulse duration, 19″ 4U rack-mountable chassis, water cooled, including an optically-linked remote controller, all-in-one box. In further embodiments, a water cooler 119 is connected to the laser box 186 as well as a fume extractor 123.

In some embodiments, the system includes at least one air knife 116 disposed in the laser box 186 or adjacent to the laser box 186. As shown in FIG. 3.2, the air knife 116 may be positioned to cut across the path of the laser beam 129 to protect the lens 133 from debris. The air knife 116 may be powered by an air compressor.

The disclosed systems may include a computing device 149 in data communication with a laser system 106 and a sensor 126. Accordingly, the laser system 106, the computing device 149, and the sensor 126 may each have a network interface, which may operate wirelessly (e.g., using radio, satellite, cellular, or WI-FI transmissions) in some embodiments, that may connect each component to a network. The computing device 149 includes at least one processor circuit, for example, having a processor and a memory, both of which are coupled (e.g., electrically coupled) to a local interface. To this end, each computing device 149 may include, for example, at least one server computer or like device. The local interface may include, for example, a data bus with an accompanying address/control bus or other bus structure as can be appreciated.

A number of software components previously discussed are stored in the memory of the respective computing devices 149 and are executable by the processor of the respective computing devices 149. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in a proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same network environment.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

### Introduction

This example shows for the first time the investigation of the effects of fiber laser parameters on the removal effectiveness of three types of concrete pavement stripes, namely, spray by truck, hot tape, and paint. The removal effectiveness included the removal time and quality, in which, the removal quality was evaluated by comparing the overall errors of grayscale tones on the images between the original pavement area before striping (namely control) and the stripe-removed area. A simple MATLAB script for calculating the average errors of grayscale difference between the laser-removed surfaces and the control was developed. The laser irradiation parameters included the average laser power (Watts), pulse frequency (kHz), pulse width (ns), velocity (mm/s), fill pitch (mm), and number of passes. The stripe removal time and removal quality were set as target variables and the laser parameters were set as input variables. The regression equations between the two target variables and the several input variables were developed for the three types of stripe materials. Finally, the optimal laser parameters were found to achieve the minimum removal time with satisfactory removal quality (acceptable errors of grayscale tones).

### Experimental Procedure

### Materials and Samples' Preparation

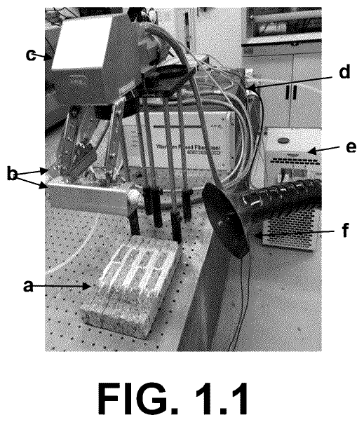

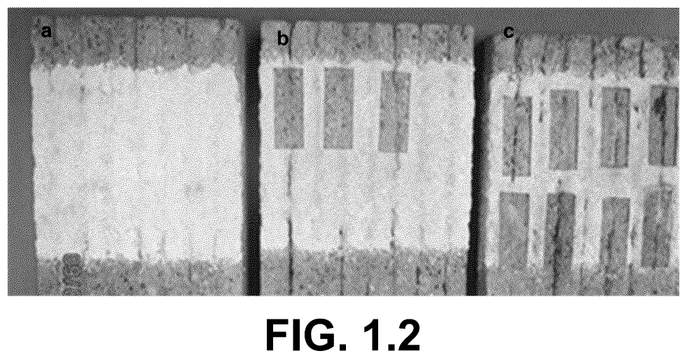

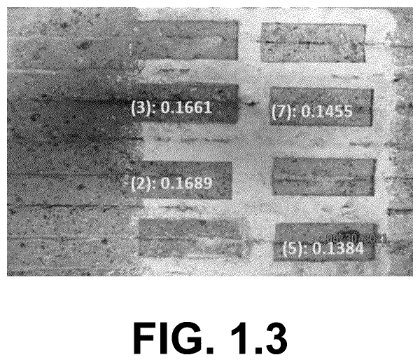

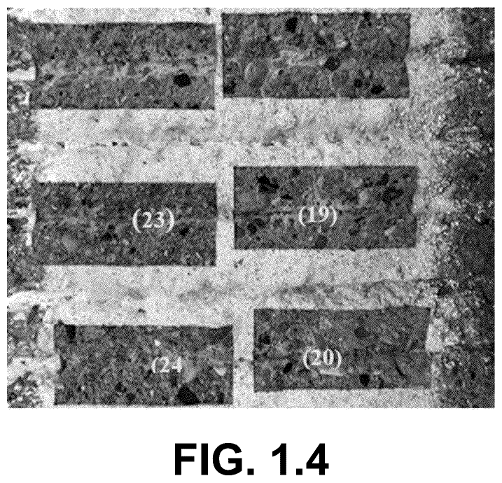

The concrete samples were made from QUIKRETE Concrete Mix purchased from the Home Depot. The concrete texturing was created manually to resemble real surface paved roads. After the concrete samples with texture were prepared (see FIG. 1.1a), three white types of concrete pavement stripes, i.e., spray by truck, hot tape, and paint were applied on the sample surfaces by Stripe-A-Zone, Inc, Texas, USA.

Thermoplastic based stripes (spray by truck, hot tape) contain elements such as calcium carbonate, glass oxide, glass, and titanium dioxide; paint stripe is made by using water paint materials.

Due to the necessity of having a retroreflective surface [Pike et al], glass beads of size of several hundred microns are partially embedded within the stripes [Pike et all]. These beads increase the overall reflectivity of the stripe, making the laser removal more difficult when using a laser wavelength in the visible range. The effect is mitigated when using IR laser wavelength, for example.

Thus, stripe removal on concrete substrate is suggested to be carried out on dry surfaces if it is possible [8]. When the laser scan applied, pop-out and cracking occurred on the stripe surface due to the rapid increase in temperature.

There are no comprehensive analyses of the effect of temperature on the stripe and concrete materials due to laser scanning. However, the thermoplastic would start to melt over 150° C. and evaporate as temperatures excess 200° C. The damage to the substrate material can be eliminated by applying optimum operational laser parameters without external distraction during the stripe removal process [27].

Ordinary Portland Cement (OPC) concrete includes 70% of CaO—SiO₂—(H2O) gel, 20% of Ca (OH)₂, ettringite (CaO·Al₂O₃·SiO₂·12(H₂O)), calcium aluminate monosulfate hydrated (4CaO·Al₂O₃·13(H₂O)), etc. Dehydration starts when heating the stripe surface and water would evaporate in a few seconds at 200° C. The hydrated chemical bonds are broken down at over 300° C. and completely broken down at over 500° C. [8]. If laser parameters are selected correctly, the high temperature usually does not affect the deep of the concrete due to its low thermal conductivity. Thus, the heat energy may not damage the concrete substrate when high temperature applies on the stripe on concrete surface for short time.

### Experimental Setup

The experimental setup is shown in FIG. 1.1. A water cooled 1060 nm pulsed fiber laser (IPG Laser GmbH) at 200 W average power, 10 mJ pulse energy, beam quality M2<14, and selectable 30-240 ns pulse duration was used in this study. FIG. 1.2 shows also: a. sample, b. pressured air knife, c. laser scan head, d. laser, e. water cooler, f. fume extractor. The laser scan head made with a galvo-mirror, which focused the laser beam using a lens of focal length 254 mm. The laser beam was positioned perpendicular to the sample. The fume absorber was used to collect fume from the ablation process and the air knives were used to protect the optics of the scanner to avoid damages to the scanner's lens, due to the presence of glass beads expelled at high speed during the ablation process.

It is important to select appropriate laser parameters in a laser removal process [12]. Several parameters must be considered during the coating removal process, which are laser wavelength (λ), laser fluence (F), pulse width (PW), and repetition rate (RR) [28]. Inappropriate selection of laser parameters may lead to overexposure, which may result in substrate damage due to the high energy density of the laser beam, whereas underexposure can leave residual contaminations on the surface of the substrate [29].

In this work, the laser operating parameters used were Average power (W), Pulse frequency (kHz), Pulse width (PW, ns), Scanning velocity (mm/s), and Fill pitch (FP, mm). The laser wavelength was fixed at 1064 nm.

### Experimental Results and Discussions

An area of 20×50 mm was ablated by the laser as shown in FIG. 1.2. FIG. 1.2a shows the sample with the original stripe, FIG. 1.2b presents the sample with three different ablated areas, and FIG. 1.2c illustrates eight ablated areas.

To improve the removal efficiency, this work was aimed at minimizing the scanning time with satisfactory Grayscale errors between the stripe removed zone and the control zone. To quantitatively analyze images, Grayscale images containing a range of gray tones can be utilized to compare sets of images (a reference and a test image) pixel by pixel from white to black, for a better representation of images. A MATLAB script was developed for calculating the average grayscale difference between the laser-removed pavement surfaces and the original pavement (as a control). Three comparison errors, i.e., RMSE, MSE and MAE, were calculated using the following equations:

Root Mean Squared Error (RMSE) assumes that the grayscale errors of n samples are estimated as (eᵢ, i=1, 2, . . . , n), which does not consider the uncertainties brought in by observation errors or the method used to compare modeling and observation results. RMSE is presented as,

$$\\ \begin{matrix}R M S E = \sqrt{\frac{1}{n} {\sum }_{i = 1}^{n} {e}_{i}^{{}^{} 2}} & Eq . 1.1\end{matrix}$$

Mean squared error (MSE): If a vector of n predictions is generated from a sample that has n data points on all variables, and Y is the vector of experimental values of the variable being predicted, with Ŷ being the predicted values (e.g., as from a least-squares fit), then the MSE of the predictor is calculated as follows:

$$\\ \begin{matrix}M S E = \frac{1}{n} {\sum }_{i = 1}^{n} {( {Y}_{i} - {\hat{Y}}_{i} )}^{2} & Eq . 1.2\end{matrix}$$

Mean absolute error (MAE) is a measure of errors between paired observations expressing the same phenomenon. Y versus X include comparisons of predicted values versus experimental values. MAE is estimated as:

$$\\ \begin{matrix}M A E = \frac{{\sum }_{i = 1}^{n} \vert {y}_{i} - {x}_{i} \vert}{n} = \frac{{\sum }_{i = 1}^{n} \vert {e}_{i} \vert}{n} & Eq . 1.3\end{matrix}$$

Thus, MAE is an arithmetic average of the absolute errors |eᵢ|=|yᵢ−ᵢ|, where yᵢ is the prediction and xᵢ the experimental values.

Lower power values (less than 200 W average output laser power) were giving unsatisfactory ablation results, as most probably the fluence threshold value was not reached for all three types of stripes. Therefore, for these experiments, the highest power of 200 W for the laser output was applied.

The Pulse frequency of 30 kHz and Pulse width of 30 ns were used for the removal of the stripe namely thermo by truck. Higher frequencies were providing a smaller ablated thickness per scanned area, resulting in a much slower process. In addition, the deposited energy resulted insufficient for generating an appreciable grooved surface for a laser pulse width higher than 30 ns.

Moreover, during these experiments, it was found that the number of changing scan directions (vertical/parallel) significantly affect the removal efficacy for all three types of stripes and therefore, the number of changing vertical/parallel direction (Number) was considered as an input variable during the analysis. Other parameters taken into consideration in this analysis were the Scanning Velocity (mm/s), the Fill pitch (mm), and the Number of changing scan direction.

### Thermo by Truck Stripes

Thirty-two laser scan runs were carried out and three errors (RMSE, MSE, and MAE) between the stripe removed zone and control ones were calculated and are presented in Table 1.1 for the thermo by truck stripe type (white color). The thickness of the stripes was about 2.5 cm.

TABLE 1.1
Laser testing parameters for removing thermoplastic stripe (Power =
200 w, Pulse frequency = 30 kHz, Pulse width = 30 (ns)

| | | | # of | | | | | |
|---|---|---|---|---|---|---|---|---|
| | Scanning | Fill | changing | | | | | |
| | speed | pitch | scan | Time | | | | Average |
| No. | (mm/s) | (mm) | direction | (s) | RMSE | MSE | MAE | Error |
| 1 | 5000 | 0.3 | 2 | 31.8 | 0.1788 | 0.027 | 0.1338 | 0.1132 |
| 2 | 2000 | 0.3 | 2 | 45.8 | 0.1689 | 0.085 | 0.1302 | 0.1280 |
| 3 | 6000 | 0.3 | 2 | 36 | 0.1661 | 0.0213 | 0.123 | 0.1035 |
| 4 | 6000 | 0.2 | 2 | 42 | 0.1686 | 0.0248 | 0.1304 | 0.1079 |
| 5 | 6000 | 0.2 | 2 | 19 | 0.1384 | 0.0395 | 0.1798 | 0.1192 |
| 6 | 8000 | 0.2 | 2 | 5.16 | 0.2128 | 0.0372 | 0.1839 | 0.1446 |
| 7 | 8000 | 0.3 | 2 | 3.78 | 0.1455 | 0.0122 | 0.1874 | 0.1150 |
| 8 | 8000 | 0.45 | 10 | 2.97 | 0.1566 | 0.045 | 0.127 | 0.1095 |
| 9 | 8000 | 0.45 | 10 | 2.66 | 0.1523 | 0.0314 | 0.116 | 0.0999 |
| 10 | 8000 | 0.45 | 8 | 2.49 | 0.1788 | 0.0378 | 0.1248 | 0.1138 |
| 11 | 8000 | 0.45 | 6 | 2.97 | 0.1802 | 0.04969 | 0.1407 | 0.1235 |
| 12 | 9800 | 0.3 | 3 | 2.72 | 0.1947 | 0.0571 | 0.1737 | 0.1418 |
| 13 | 9000 | 0.2 | 2 | 12 | 0.2988 | 0.0878 | 0.2148 | 0.2005 |
| 14 | 10000 | 0.5 | 2 | 7.9 | 0.1921 | 0.0796 | 0.1705 | 0.1474 |
| 15 | 10000 | 0.3 | 2 | 4.55 | 0.1954 | 0.0778 | 0.1494 | 0.1409 |
| 16 | 9000 | 0.45 | 6 | 2.84 | 0.1771 | 0.0471 | 0.1157 | 0.1133 |
| 17 | 9000 | 0.3 | 6 | 3.36 | 0.1601 | 0.0601 | 0.1491 | 0.1231 |
| 18 | 9000 | 0.5 | 8 | 2.33 | 0.1902 | 0.0485 | 0.1491 | 0.1293 |
| 19 | 9000 | 0.3 | 8 | 2.97 | 0.1507 | 0.0228 | 0.1259 | 0.0998 |
| 20 | 9000 | 0.2 | 8 | 5.01 | 0.2177 | 0.0313 | 0.1429 | 0.1306 |
| 21 | 9000 | 0.4 | 8 | 6.6 | 0.1749 | 0.038 | 0.1426 | 0.1185 |
| 22 | 10000 | 0.3 | 8 | 4.63 | 0.1714 | 0.0348 | 0.1415 | 0.1159 |
| 23 | 8000 | 0.3 | 8 | 5.88 | 0.1805 | 0.0527 | 0.1522 | 0.1285 |
| 24 | 1000 | 0.8 | 4 | 15.22 | 0.2386 | 0.0395 | 0.1833 | 0.1538 |
| 25 | 1000 | 0.8 | 6 | 11.33 | 0.1999 | 0.04 | 0.1606 | 0.1335 |
| 26 | 3000 | 0.7 | 5 | 17.34 | 0.2167 | 0.0588 | 0.1915 | 0.1557 |
| 27 | 7000 | 0.5 | 1 | 14.22 | 0.2678 | 0.0683 | 0.2281 | 0.1881 |
| 28 | 4000 | 0.5 | 3 | 13.01 | 0.2108 | 0.0478 | 0.1348 | 0.1311 |
| 29 | 3000 | 0.7 | 1 | 10.24 | 0.2688 | 0.0778 | 0.1948 | 0.1805 |
| 31 | 7000 | 0.6 | 4 | 12.63 | 0.1678 | 0.0353 | 0.1381 | 0.1137 |
| 31 | 5000 | 0.7 | 3 | 10.33 | 0.2378 | 0.0553 | 0.1981 | 0.1637 |
| 32 | 2000 | 0.9 | 1 | 15.66 | 0.2678 | 0.08653 | 0.2181 | 0.1908 |

As an example, the photo of the thermo by truck stripe removal Sample #1 is shown in FIG. 1.3. Scans (2, 3, 5 and 7) have RMSE errors of 0.1689, 0.1661, 0.1348 and 0.1455, which achieved satisfied scan qualities.

According to Table 1.1, it was found that the shortest scanning time of 2.33-4 s (with the average errors smaller than 0.13) can be achieved with the following laser parameters: Pulse frequency of 30 kHz, Pulse width of 30 ns, Number of passes of 2-10, Velocity of 8000-9000 mm/s, Fill pitch of 0.3-0.5 mm, and Number of changing scan direction of 2-10. Assuming that the 10 cm² (1.6 in²) area of stripe can be cleaned in 4 seconds, the speed of removing 10.16 cm (standard width) thermo by truck stripe is 0.1524 m/min. To explore the relationship between target variables (cleanness time and grey scale error) and input variables, and to optimize the parameters' selection, firstly linear regression models were applied in this study; however, the R² values found were relatively low; thus, nonlinear regression models were used to analyze the relationships between the target variables and the input variables for the experimental data in Table 1.1.

The nonlinear regression models are as follows:

Scan time(s)=128.616−0.014×S−239.889×FP−0.981×N++2.88×10⁻⁷×V2+124.348×FP²−0.019×N²+0.016×V×FP+3.56×10⁻⁵×V×N+0.669×FP×Number Eq. 1.6

which resulted in R²=0.798 (R²=0.671 for linear regression analysis), and,

Grayscale error=0.0589.66×10⁻⁶×S+0.2×FP−0.005×N++1.05×V²−0.018×FP²+0.001×N²−+1.53×10⁻⁵×V×FP−4.34×10⁻⁷×V×N'0.011×FP×N Eq. 1.7

which resulted in R²=0.604 (R²=0.469 for linear regression analysis).

In Eqs. 1.6 and 1.7, Scanning speed S is the laser scan velocity (mm/s), FP is the filling pitch (mm), and Number is the number of changing scan directions. The R² values found showed that the nonlinear regression model can describe the relationship between the two target variables and the input variables more accurately than the linear models for stripe removal.

### Hot Tape Stripes

Laboratory tests (24 ablated areas) for removing hot tape stripes were performed. The thickness of the white hot-tape stripe was about 3.6 mm. As previously described, due to the need to reach the energy threshold for the ablation of the stripe, the highest average output power of 200 W was selected for the laser. The Pulse frequency of 30 kHz and Pulse width of 30 ns were used for the removal of hot tape stripe as well. Three parameters, i.e., Velocity (mm/s), Fill pitch (mm), and Number of changing scan direction were used in this case. Twenty-four laser scan runs were carried out and the three errors (RMSE, MSE, and MAE) between the stripe removed zone and control ones were calculated and are presented in Table 1.2.

TABLE 1.2
Laser testing parameters for removing hot tape stripe on concrete (Power = 200 w,
Pulse frequency = 30 kHz, Pulse width = 30 ns, # of passes = 2-3)

| | | | # of | | | | | |
|---|---|---|---|---|---|---|---|---|
| | Scanning | Fill | changing | | | | | |
| | speed | pitch | scan | Time | | | | Average |
| No. | (mm/s) | (mm) | direction | (s) | RMSE | MSE | MAE | Error |
| 1 | 1000 | 0.3 | 12 | 125.1 | 0.1955 | 0.0482 | 0.1624 | 0.1354 |
| 2 | 1000 | 0.3 | 12 | 130.2 | 0.1762 | 0.0315 | 0.1381 | 0.1153 |
| 3 | 1000 | 0.2 | 12 | 141.3 | 0.1641 | 0.0219 | 0.1194 | 0.1018 |
| 4 | 3000 | 0.2 | 12 | 65.2 | 0.2166 | 0.0469 | 0.1732 | 0.1456 |
| 5 | 2000 | 0.2 | 12 | 96.5 | 0.1941 | 0.0377 | 0.1586 | 0.1301 |
| 6 | 1000 | 0.2 | 12 | 145.2 | 0.1481 | 0.0219 | 0.1173 | 0.0958 |
| 7 | 1000 | 0.2 | 10 | 122.6 | 0.1511 | 0.0228 | 0.1216 | 0.0985 |
| 8 | 1000 | 0.3 | 4 | 105.9 | 0.1743 | 0.0304 | 0.1418 | 0.1155 |
| 9 | 1000 | 0.2 | 6 | 90.1 | 0.2116 | 0.0448 | 0.1683 | 0.1416 |
| 10 | 500 | 0.2 | 2 | 157.7 | 0.1924 | 0.037 | 0.1506 | 0.1267 |
| 11 | 1000 | 0.2 | 6 | 62.0 | 0.2078 | 0.0482 | 0.1638 | 0.1399 |
| 12 | 1000 | 0.2 | 8 | 84.0 | 0.1994 | 0.0458 | 0.1671 | 0.1065 |
| 13 | 1000 | 0.2 | 10 | 106.1 | 0.1818 | 0.0331 | 0.1449 | 0.1199 |
| 14 | 1000 | 0.3 | 10 | 102.6 | 0.1723 | 0.0297 | 0.1383 | 0.1134 |
| 15 | 1000 | 0.3 | 10 | 102.6 | 0.1644 | 0.0307 | 0.1314 | 0.1088 |
| 16 | 1000 | 0.3 | 10 | 102.6 | 0.2301 | 0.0529 | 0.1885 | 0.1572 |
| 17 | 1000 | 0.2 | 10 | 128.6 | 0.177 | 0.0313 | 0.1393 | 0.1159 |
| 18 | 1000 | 0.2 | 10 | 81.7 | 0.1811 | 0.0328 | 0.1467 | 0.1202 |
| 19 | 1000 | 0.2 | 10 | 120.3 | 0.1412 | 0.0199 | 0.1133 | 0.0915 |
| 20 | 1000 | 0.2 | 8 | 127.9 | 0.1511 | 0.0228 | 0.1217 | 0.0985 |
| 21 | 1000 | 0.2 | 6 | 95.2 | 0.1605 | 0.0257 | 0.1254 | 0.1039 |
| 22 | 2000 | 0.2 | 6 | 76.5 | 0.1605 | 0.0257 | 0.1254 | 0.1039 |
| 23 | 4000 | 0.2 | 6 | 70.3 | 0.2015 | 0.0657 | 0.1692 | 0.1455 |
| 24 | 6000 | 0.2 | 6 | 65.3 | 0.2305 | 0.0857 | 0.1843 | 0.1668 |

Similarly, an area of 2×5 cm hot tape stripe was removed by laser ablation. According to Table 1.2, it was found that the shortest scanning time of 62-90 s (with the average errors smaller than 0.15) can be achieved with the following laser parameters: Pulse frequency of 30 kHz, Pulse width of 30 ns, Number of passes of 2-3, Velocity of 1000-3000 mm/s, Fill pitch of 0.2 mm, and Number of changing scan direction of 6-10.

The speed of removing for a 10.16 cm width hot tape stripe is 0.0071 m/min. Also here, nonlinear regression analysis was carried out. The result obtained is shown in Eq. 1.8 and Eq. 1.9 as below:

Scan time(s)=22.18+0.077×S+1187.723×FP−23.823×N++2.69E−06×V²−1624.593×FP²+2.161×N−+0.372×V×FP−0.004×V×N−11.397×FP×N Eq. 1.8

### R²=0.776

Error=8.507+1.00×10⁻³×S−71.68×FP−0.015×Number−+1.80×10⁻⁹×V²+148.92×FP²−2.30×10⁻⁵×N²−+3.00×10⁻³×V×FP+1.06×10⁻⁶×V×N+0.052×FP×N Eq. 1.9

### R²=0.716

As shown in FIG. 1.4, Scans (19), (20), (23) and (24) with average grayscale errors of 0.0942, 0.0985, 0.0923, and 0.0951, respectively removed all stripes and achieved satisfied qualities.

### Water-Based Paint Stripes

Twenty-four laboratory tests for removing paint stripes as presented in Table 1.3. The thickness of the white paint stripe was about 1 mm.

TABLE 1.3
Laser testing parameters for removing paint stripe on concrete (Power = 200
w, Pulse frequency = 30 kHz and # of passes = 3)

| | | | | # of | | | | | |
|---|---|---|---|---|---|---|---|---|---|
| | Pulse | Scanning | Fill | changing | | | | | |
| | width | speed | pitch | scan | Time | | | | Average |
| No. | (ns) | (mm/s) | (mm) | direction | (s) | RMSE | MSE | MAE | Error |
| 1 | 30 | 1000 | 0.2 | 2 | 30 | 0.173 | 0.0335 | 0.1315 | 0.1127 |
| 2 | 30 | 1000 | 0.3 | 2 | 19.6 | 0.2618 | 0.0684 | 0.2221 | 0.1453 |
| 3 | 30 | 2000 | 0.2 | 2 | 10.7 | 0.2832 | 0.0802 | 0.2613 | 0.2082 |
| 4 | 60 | 2000 | 0.2 | 2 | 10.6 | 0.2411 | 0.0581 | 0.1614 | 0.1535 |
| 5 | 60 | 2000 | 0.2 | 4 | 30.6 | 0.1573 | 0.0247 | 0.1233 | 0.1018 |
| 6 | 120 | 2000 | 0.2 | 4 | 30.6 | 0.144 | 0.0207 | 0.113 | 0.0926 |
| 7 | 240 | 4000 | 0.2 | 6 | 15 | 0.2197 | 0.042 | 0.1677 | 0.1431 |
| 8 | 240 | 1000 | 0.45 | 4 | 44.7 | 0.2286 | 0.0522 | 0.1992 | 0.1600 |
| 9 | 60 | 4000 | 0.3 | 4 | 27.6 | 0.1694 | 0.0287 | 0.1479 | 0.1153 |
| 10 | 60 | 4000 | 0.3 | 6 | 13 | 0.2158 | 0.0466 | 0.1695 | 0.1440 |
| 11 | 60 | 4000 | 0.2 | 6 | 16.9 | 0.191 | 0.0365 | 0.1547 | 0.1274 |
| 12 | 60 | 4000 | 0.2 | 8 | 26.3 | 0.1671 | 0.0279 | 0.1313 | 0.1088 |
| 13 | 60 | 4000 | 0.3 | 8 | 30.7 | 0.1544 | 0.0238 | 0.1193 | 0.0992 |
| 14 | 60 | 2800 | 0.3 | 6 | 29 | 0.1506 | 0.0231 | 0.1151 | 0.0963 |
| 15 | 60 | 3300 | 0.2 | 6 | 32.2 | 0.1531 | 0.025 | 0.1213 | 0.0998 |
| 16 | 60 | 3000 | 0.2 | 6 | 31.7 | 0.1554 | 0.0242 | 0.1225 | 0.1007 |
| 17 | 60 | 5000 | 0.2 | 10 | 35.5 | 0.1373 | 0.0189 | 0.1099 | 0.0887 |
| 18 | 60 | 5000 | 0.3 | 10 | 34.2 | 0.146 | 0.0213 | 0.1145 | 0.0939 |
| 19 | 60 | 5000 | 0.4 | 8 | 23.5 | 0.1449 | 0.021 | 0.1167 | 0.0942 |
| 20 | 60 | 2000 | 0.4 | 6 | 22.7 | 0.1532 | 0.0235 | 0.1188 | 0.0985 |
| 21 | 60 | 2000 | 0.45 | 8 | 30.2 | 0.175 | 0.0306 | 0.1424 | 0.1160 |
| 22 | 30 | 2000 | 0.45 | 8 | 30.2 | 0.1784 | 0.0315 | 0.1477 | 0.1192 |
| 23 | 30 | 6000 | 0.3 | 12 | 24.1 | 0.1428 | 0.0204 | 0.1136 | 0.0923 |
| 24 | 30 | 8000 | 0.3 | 16 | 25.9 | 0.1462 | 0.0214 | 0.1177 | 0.0951 |

Four parameters, i.e., Pules width (PW, ns), Scanning speed (mm/s), Fill pitch (FP, mm), and Number of changing scan direction were used in the regression analysis. According to the experimental data, the nonlinear regression method was used to analyze the relationship between the 4 input variables and target variable of Scan time (s). The result obtained is shown in Eq. 1.10. The nonlinear relationship between input variables and target variable of grayscale error is presented in Eq. 1.11.

Scan time (s)=47.249−0.269×PW−0.051×S−32.19×FP++25.375×N+0×PW2−7.60×10⁻⁶×V⁻+282.212×FP²+1.724×N²+4.52×10^{-5×}PW×V++1.22×PW×FP−0.018×PW×N+0.111×V×FP−+0.007×V×N−49.679×FP×N Eq. 1.10

### R²=0.867

Error=0.113+0×PW+×S+0.115×FP−0.096×N++5.16×10⁻⁶×PW²−1.52×10^{-8×}V²+0.654×FP²−+0.001×N²−7.65×10^{-7×}PW×V−0.005×PW×FP++0×PW×N+0×V×FP+9.94×10⁻⁶×V×N+0.121×FP×N Eq. 1.11

### R²=0.913

In Eqs. 1.10 and 1.11, PW is Pulse width (ns), S is the Scanning speed (the laser scan velocity (mm/s)), FP is the filling pitch (mm), and Number is the number of changing scan directions.

In the lab tests, an area of 2×5-cm paint stripe was removed by the laser ablation for each test as shown in FIG. 1.4. According to Table 1.3, it was found that the shortest scanning time of 16.9-36 s (with the average errors smaller than 0.13) can be achieved with the following laser parameters: Pulse frequency of 30 kHz, Pulse width of 30 ns, Number of passes of 2-10, Velocity of 8000-9000 mm/s, Fill pitch of 0.3-0.5 mm, and Number of changing scan direction of 2-10; the speed of removing a 10.16-cm paint stripe is 0.0177 m/min.

### CONCLUSIONS

In this work, the influences of laser irradiation parameters on the removal effectiveness of three types of stripes (thermo by truck, hot tape, and paint) from concrete pavements were experimentally investigated. The removal effectiveness included the removal time and quality, in which, the removal quality was evaluated in close proximity by comparing errors of grayscale tones on the images between the original pavement area before striping and the stripe-removed area. A MATLAB script for calculating the average grayscale difference between the laser-removed surfaces and the control surface was developed. The laser irradiation parameters included the average laser power (Watts), pulse frequency (kHz), pulse width (ns), scanning speed (mm/s), fill pitch (mm), number of passes, and number of changing scan directions. The targets were to minimize the total scan time (in seconds) and best scan quality (smallest errors of grayscale gray tones)

The results showed that the laser removal of stripes from concrete was highly successful. Among the three stripes, the thermo by truck stripe was the fastest one to be removed by the laser, followed by the paint stripes, while the hot tape stripes (higher thickness) were the slowest to be ablated. Moreover, although paint stripes were removed faster than hot tape stripes, due to the very low thickness, they resulted to be more difficult to be removed due probably to the reflectivity of the material for the wavelength of the laser used. According to the small lab-scale experiments (removing an area of 50-mm×20-mm, each laser scan), it was found that the removing speed for a 10.16 cm width stripe can be 0.1524 m/min for the thermo by truck stripe, 0.0177 m/min for the paint stripe, and 0.0071 m/for the hot tape stripe. The removal speeds can be increased by preparing the surface using some mechanical technique (for example flying), which can remove exposed glass beads to reduce the overall retroreflectivity of the surface. Moreover, to meet the stripe removal speed requirements compared to other methods, one possible solution would be to increase the output power of the laser (e.g., over 1000 W) and its frequency (>200 KHz), which can significantly increase the removal speed for real stripe removal practice.

### REFERENCES FOR EXAMPLE 1

[1] “2009 MUTCD with Revisions 1 and 2, May 2012—Knowledge—FHWA MUTCD.” https://mutcd.fhwa.dot.gov/kno_2009r1r2.htm (accessed Mar. 12, 2022).

[2] K. Berg and S. Johnson, “Field Comparison of Five Pavement Marking Removal Technologies,” 2009.

[3] Y. Cho, K. Kabassi, J.-H. Pyeon, K. Choi, C. Wang, and T. Norton, “Effectiveness Study of Methods for Removing Temporary Pavement Markings in Roadway Construction Zones,” Journal of Construction Engineering and Management, vol. 139, no. 3, pp. 257-266, Mar. 2013, doi: 10.1061/(ASCE)C0.1943-7862.0000608.

[4] J.-H. Pyeon, “Development of Improved Procedures for Removing Temporary Pavement Markings during Highway Construction,” 2005.

[5] H. Pew and J. Thorne, “Laser removal of paint on pavement,” 2000.

[6] J. S. Pozo-Antonio, T. Rivas, M. P. Fiorucci, A. J. Lopez, and A. Ramil, “Effectiveness and harmfulness evaluation of graffiti cleaning by mechanical, chemical and laser procedures on granite,” Microchemical Journal, vol. 125, pp. 1-9, Mar. 2016, doi: 10.1016/j.microc.2015.10.040.

[7] K. Liu and E. Garmire, “Paint removal using lasers,” Appl. Opt., AO, vol. 34, no. 21, pp. 4409-4415, Jul. 1995, doi: 10.1364/AO.34.004409.

[8] G. Daurelio, I. M. Catalano, and P. Bassi, “Laser paint removal on the outside walls of the Church Abbey Saint Adoeno in Bisceglie (BAT), Italy: a case study,” Sofia, Bulgaria, Sep. 2010, pp. 77511S-77511S-10. doi: 10.1117/12.879897.

[9] V. Gomes, A. Dionisio, J. S. Pozo-Antonio, T. Rivas, and A. Ramil, “Mechanical and laser cleaning of spray graffiti paints on a granite subjected to a SO2-rich atmosphere,” Construction and Building Materials, vol. 188, pp. 621-632, Nov. 2018, doi: 10.1016/j.conbuildmat.2018.08.130.

[10] P. Sanmartin, F. Cappitelli, and R. Mitchell, “Current methods of graffiti removal: A review,” Construction and Building Materials, vol. 71, pp. 363-374, Nov. 2014, doi: 10.1016/j.conbuildmat.2014.08.093.

[11] “Enhancement of graffiti removal from heritage stone by combining laser ablation and application of a solvent mixture—ScienceDirect.” https://www.sciencedirect.com/science/article/abs/pii/S0950061820319395 (accessed Mar. 15, 2022).

[12] P. Sanjeevan and A. Klemm, “A review of laser technique application in cleaning process of porous construction materials,” 2005.

[13] P. Sanjeevan, A. J. Klemm, and P. Klemm, “Removal of graffiti from the mortar by using Q-switched Nd:YAG laser,” Applied Surface Science, vol. 253, no. 20, pp. 8543-8553, Aug. 2007, doi: 10.1016/j.apsusc.2007.04.030.

[14] M. P. Fiorucci, A. J. López, A. Ramil, S. Pozo, and T. Rivas, “Optimization of graffiti removal on natural stone by means of high repetition rate UV laser,” Applied Surface Science, vol. 278, pp. 268-272, Aug. 2013, doi: 10.1016/j.apsusc.2012.10.092.

[15] T. Rivas, S. Pozo, M. P. Fiorucci, A. J. López, and A. Ramil, “Nd:YVO4 laser removal of graffiti from granite. Influence of paint and rock properties on cleaning efficacy,” Applied Surface Science, vol. 263, pp. 563-572, Dec. 2012, doi: 10.1016/j.apsusc.2012.09.110.

[16] A. Ramil, J. S. Pozo-Antonio, M. P. Fiorucci, A. J. López, and T. Rivas, “Detection of the optimal laser fluence ranges to clean graffiti on silicates,” Construction and Building Materials, vol. 148, pp. 122-130, Sep. 2017, doi: 10.1016/j.conbuildmat.2017.05.035.

[17] “Coatings|Free Full-Text I Laser-Assisted Removal of Graffiti from Granite: Advantages of the Simultaneous Use of Two Wavelengths.” https://www.mdpi.com/2079-6412/8/4/124 (accessed Mar. 12, 2022).

[18] J. Penide et al., “Removal of graffiti from quarry stone by high power diode laser,” Optics and Lasers in Engineering, vol. 51, no. 4, pp. 364-370, Apr. 2013, doi: 10.1016/j.optlaseng.2012.12.002.

[19] G. Daurelio, E. S. Andriani, A. Albanese, I. M. Catalano, G. Teseo, and D. Marano, “Removal of graffiti paintings from the Mansion de Mattis site in Corato (Bari), Italy: Laser deveiling or complete cleaning?,” Lisboa, Portugal, Oct. 2008, p. 713129. doi: 10.1117/12.816822.

[20] G. R. Dascalu, M. C. Stancu, M. Dinu, and N. Puscas, “Laser cleaning of polychrome artworks. Case study on graffiti,” University Politehnica of Bucharest Scientific Bulletin-Series a-Applied Mathematics and Physics, vol. 82, no. 1, pp. 307-316, 2020.

[21] S. Samolik, M. Walczak, M. Plotek, A. Sarzynski, I. Pluska, and J. Marczak, “Investigation into the removal of graffiti on mineral supports: Comparison of nano-second Nd:YAG laser cleaning with traditional mechanical and chemical methods,” Studies in Conservation, vol. 60, no. sup1, pp. S58-S64, Aug. 2015, doi: 10.1179/0039363015Z.000000000208.

[22] A. J. Lopez, J. Lamas, J. S. Pozo-Antonio, T. Rivas, and A. Ramil, “Development of processing strategies for 3D controlled laser ablation: Application to the cleaning of stonework surfaces,” Optics and Lasers in Engineering, vol. 126, p. 105897, Mar. 2020, doi: 10.1016/j.optlaseng.2019.105897.

[23] “Laser cleaning of steel structure surface for paint removal and repaint adhesion.” https://www.oejournal.org/article/doi/10.3969/j.issn.1003-501X.2017.03.009?viewType=HTML (accessed Mar. 12, 2022).

[24] L. Lazov, N. Angelov, E. Teirumnieks, I. Adijāns, A. Pacejs, and Ē. Teirumnieka, “LASER ABLATION OF PAINT COATINGS IN INDUSTRY,” ENVIRONMENT. TECHNOLOGIES. RESOURCES. Proceedings of the International Scientific and Practical Conference, vol. 3, no. 0, Art. no. 0, Jun. 2021, doi: 10.17770/etr2021vo13.6662.

[25] “Laser scattering measurement for laser removal of graffiti.” https://www.spiedigitallibrary.org/conference-proceedings-of-spie/9659/96590T/Laser-scattering-measurement-for-laser-removal-of-graffiti/10.1117/12.2196112.short?SSO=1 (accessed Mar. 15, 2022).

[26] S. Siano et al., “Laser cleaning in conservation of stone, metal, and painted artifacts: state of the art and new insights on the use of the Nd:YAG lasers,” Appl. Phys. A, vol. 106, no. 2, pp. 419-446, Feb. 2012, doi: 10.1007/s00339-011-6690-8.

[27] J. Han, X. Cui, S. Wang, G. Feng, G. Deng, and R. Hu, “Laser effects based optimal laser parameter identifications for paint removal from metal substrate at 1064 nm: a multi-pulse model,” Journal of Modern Optics, vol. 64, no. 19, pp. 1947-1959, Oct. 2017, doi: 10.1080/09500340.2017.1330433.

[28] F. Brygo, Ch. Dutouquet, F. Le Guern, R. Oltra, A. Semerok, and J. M. Weulersse, “Laser fluence, repetition rate and pulse duration effects on paint ablation,” Applied Surface Science, vol. 252, no. 6, pp. 2131-2138, Jan. 2006, doi: 10.1016/j.apsusc.2005.02.143.

[29] X. Li, Q. Zhang, X. Zhou, D. Zhu, and Q. Liu, “The influence of nanosecond laser pulse energy density for paint removal,” Optik, vol. 156, pp. 841-846, 2018.

### Example 2

Laser irradiation has been successfully used in cleaning graffiti from porous construction surfaces, removing paints from metal surfaces due to its low environmental pollution, high cleaning precision, and efficiency compared with traditional ways. In this work, the influence of laser irradiation parameters on the removal effectiveness of three types of stripes (thermo by truck, hot tape, and paint) from a concrete surface and one type of stripe (paint) from asphalt surface were experimentally investigated. The removal effectiveness included the removal time and quality, in which, the removal quality was evaluated by using a MATLAB script that compared errors of Grayscale tones on the images taken from samples between the original pavement area before striping and the stripe-removed area. The laser irradiation parameters included the average laser power (Watts), pulse frequency (kHz), pulse width (ns), scanning speed (mm/s), fill pitch (mm), number of passes, and number of changing scan directions. This project was aimed at minimizing the laser scan time (s) and achieving satisfactory scan quality (small errors of Grayscale gray tones). To examine the effectiveness of the Grayscale comparison method for real road stripe removal, we took photos from stripe samples in daytime and nighttime and compared their Root Mean Squared Errors (RMSEs) with those photos taken inside the laboratory (artificial light). The results indicated that the Grayscale errors of under sunlight and at night photos are linearly related to that of in-door photos with acceptable correlation coefficients (R²). Therefore, the tool can be used to evaluate the removal effectiveness also for the road test use.

The laboratory test results showed the laser removal of stripes from concrete was highly successful. Among the three stripes on concrete, thermo by truck stripe is the easiest one to be removed by laser, followed by paint, and hot tape stripes were the most difficult one (due to the higher thickness). According to the small lab-scale experiments (removing an area of 2-in×0.8-in, i.e., 50-mm×20-mm, each laser scan), it was found that the removing speed for 4-in width stripe can be 1.7 ft/min (0.0193182 miles/hr) for thermo by truck stripes, 0.065 ft/min (0.0007386 miles/hr) for paint stripes, and 0.31 ft/min (0.0035227 miles/hr) for hot tape stripes. The removal speeds can be increased by preparing the surface with some mechanical technique (to remove exposed glass beads). It should be kept in mind that this study was carried out using a laser with 200 W in average power, a tiny scanning zone, and a limited number of replications. To meet the stripe removal speed requirements in the real case, one possible solution would be to increase the output power of the laser (e.g., over 1000 W) and/or its frequency (over 200 KHz); this would be able to significantly increase the removal speed for real pavement stripe removal practice that is comparable or even superior to current methods such as hydro blasting and grinding. For example, assuming same laser's characteristics of the one used for these experiments but with an average output power of 1000 W, it can be projected to have a removal speed of ˜53 ft/min (0.60 miles/hr) for thermoplastic stripes, 44.6 ft/min (0.51 miles/hr) for the hot tape stripe, and 158 ft/min (1.79 miles/hr) for the paint stripe. These values are of the same magnitude of grinding and water blasting removal speeds if not higher in the case of paint.

### Introduction

The stripes on the pavement must be completely removed without causing damage to the road surface, which is a real challenge. Sometimes these stripes are even more difficult to be removed than the underlying asphalt for example. Moreover, the pavements are very porous, allowing the striping materials to penetrate through surface pores into the deeper substrate. Some methods work well with a specific type of stripe material and/or on a specific surface type.

The main objective of this research project is to evaluate the most effective methods for stripe removal to include but not be limited to a fully working prototype laser system to remove pavement marking stripes from roadways. As part of the scope of work, laboratory tests were made, checking the influences of laser irradiation parameters on the removal effectiveness of three types of stripes materials (thermo by truck, hot tape, and paint) from concrete pavements and one type of stripe material (paint) from asphalt. Detailed findings from these efforts are presented in this Technical Memorandum.

This project was aimed at investigating experimentally the effects of fiber laser parameters on the removal effectiveness of three types of concrete pavement stripes, namely, thermo by truck, hot tape, and paint. The removal effectiveness included the removal time and quality, in which, the removal quality was evaluated by comparing errors of Grayscale tones on the images between the original pavement area before striping (control) and the stripe-removed area. A MATLAB program for calculating the average errors of grayscale difference between the laser-removed surfaces and the control was developed. The laser irradiation parameters included the average laser power (Watts), pulse frequency (kHz), pulse width (ns), scanning speed (mm/s), fill pitch (mm), and the number of passes. The stripe removal time and removal quality were set as target variables and the laser parameters were as input variables. The regression equations between the two target variables and several input variables were developed for the three types of stripe materials (thermoplastic, hot tape, and paint). Finally, the optimal laser parameters were found to achieve the minimum removal time with satisfactory removal quality (acceptable errors of Grayscale tones).

### Materials, Software, and Experimental Setup

### Concrete Samples Preparation

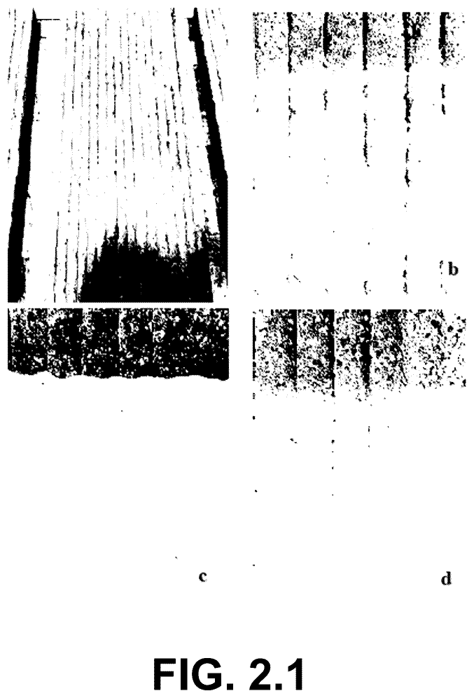

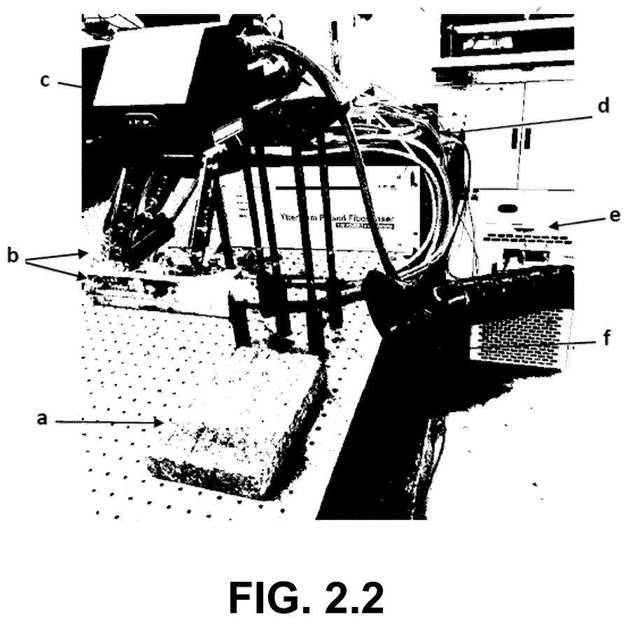

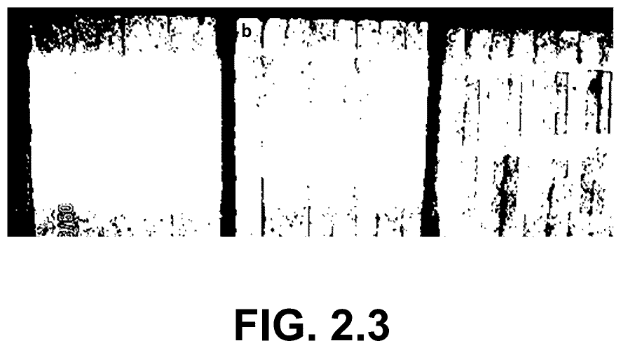

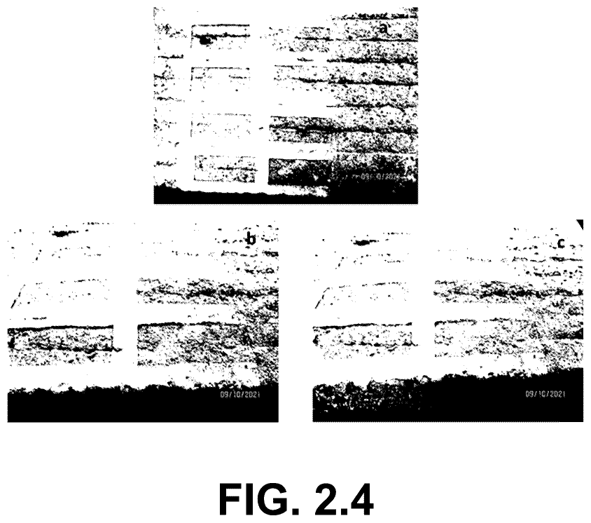

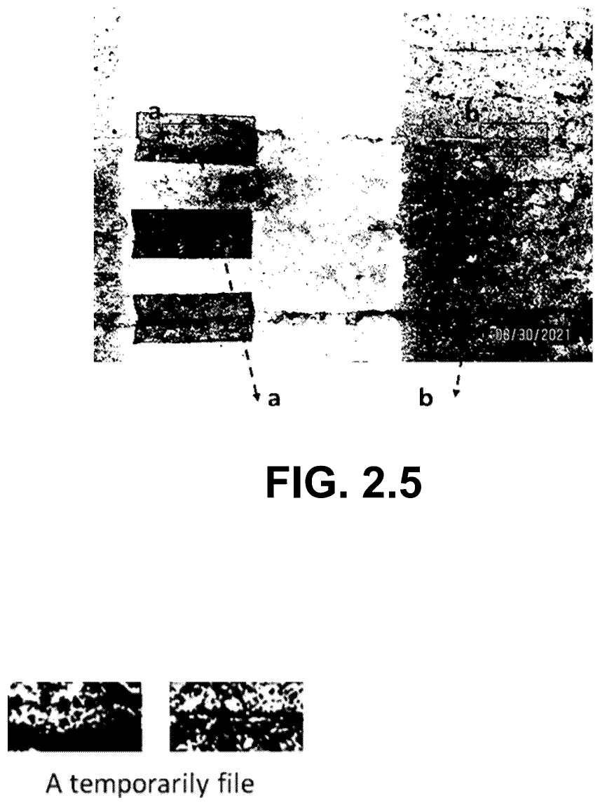

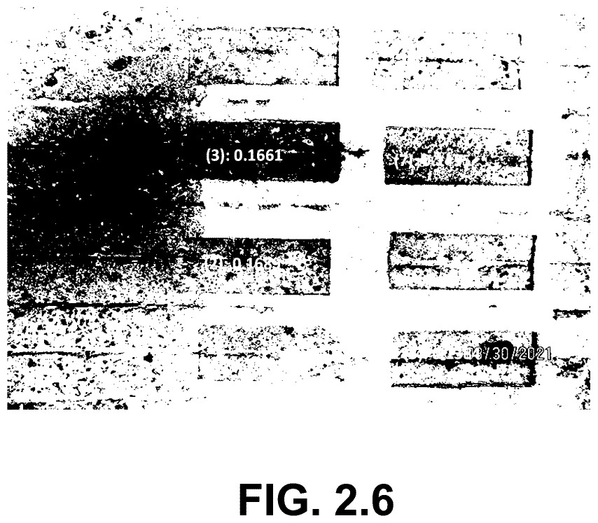

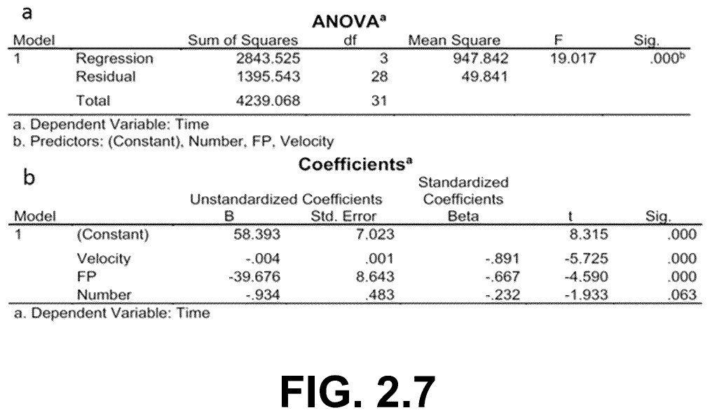

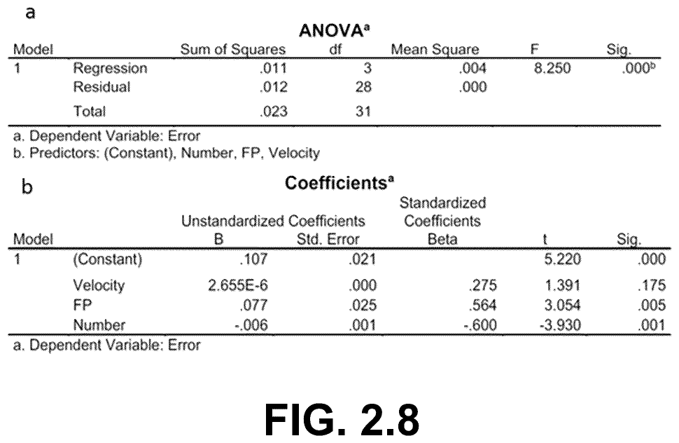

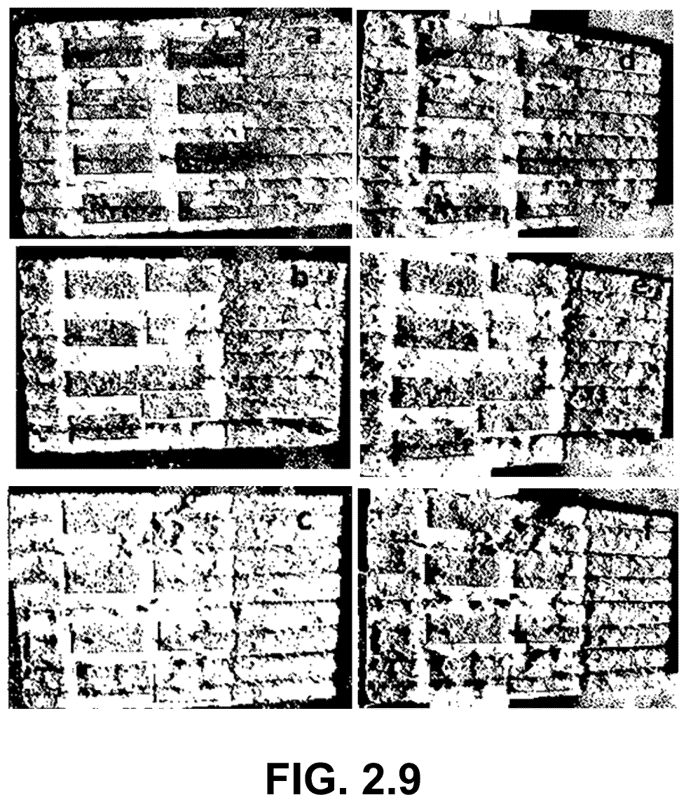

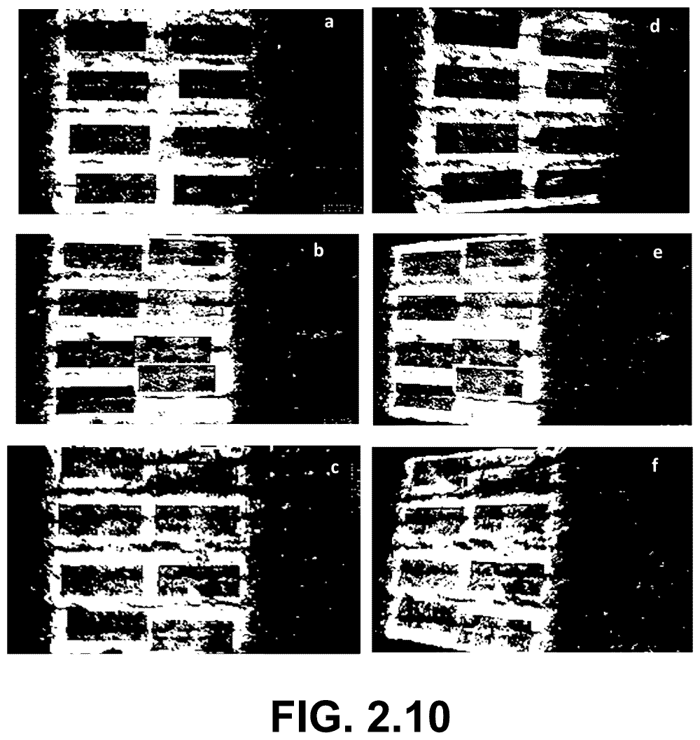

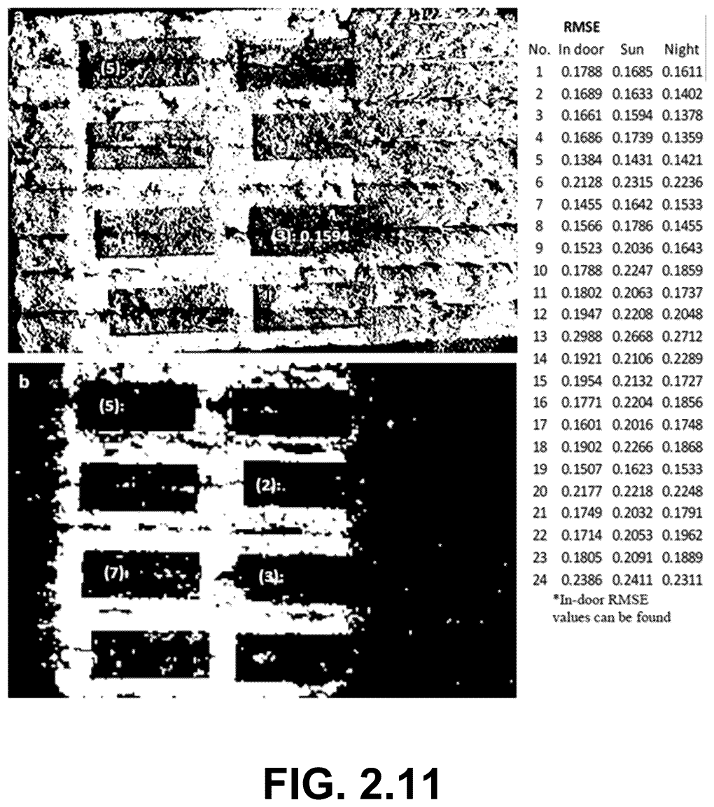

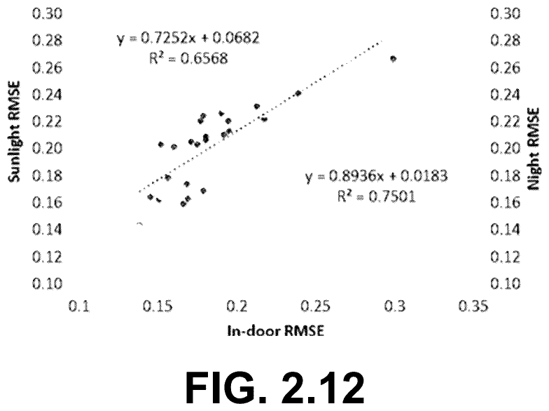

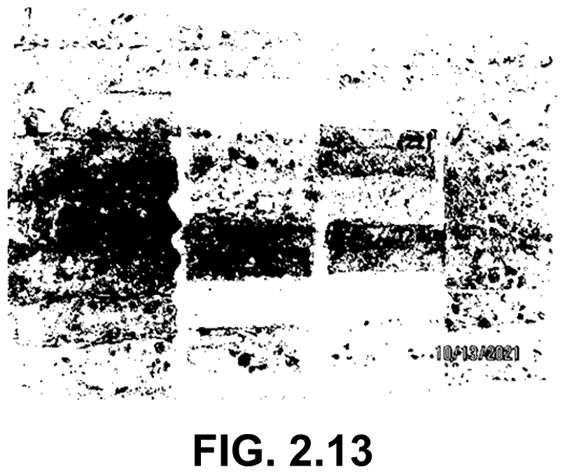

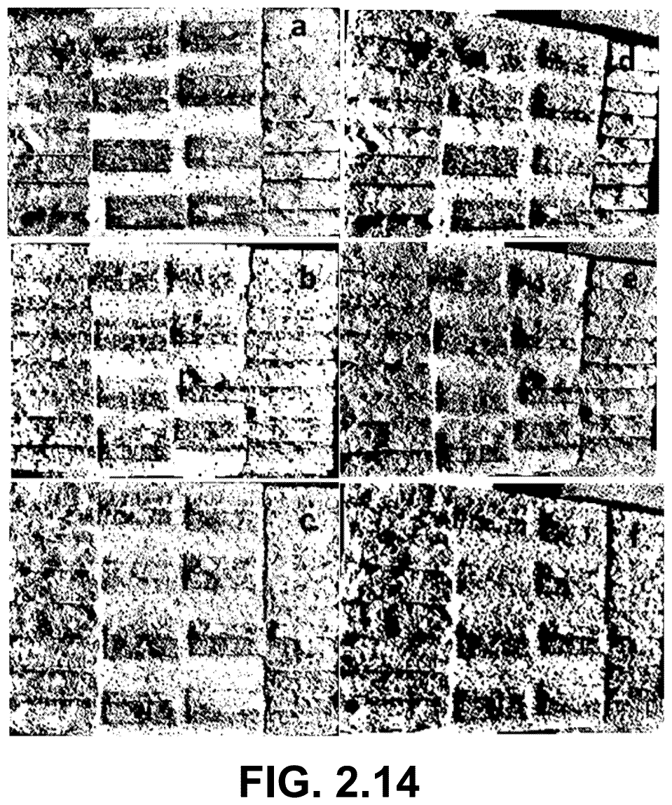

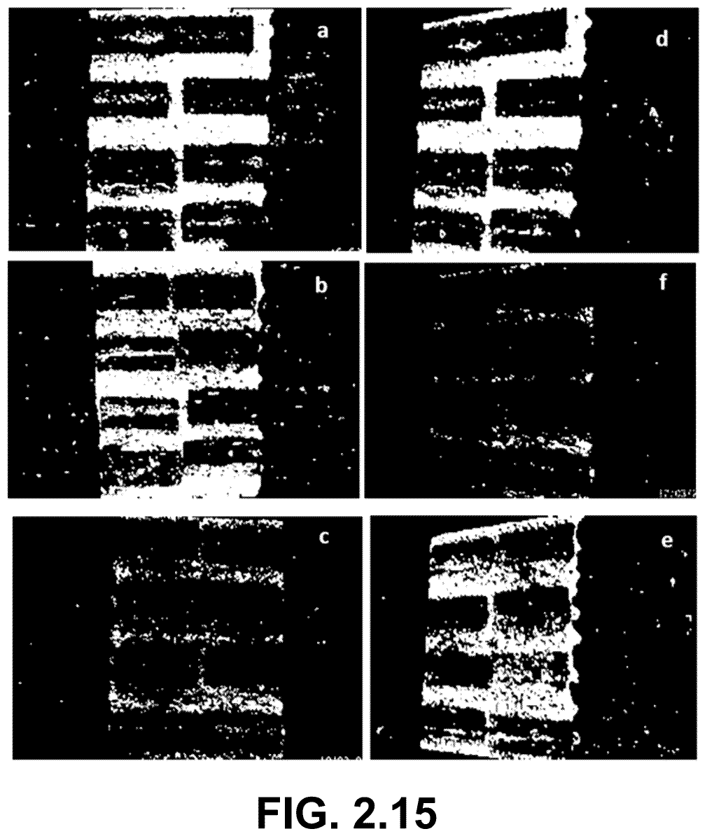

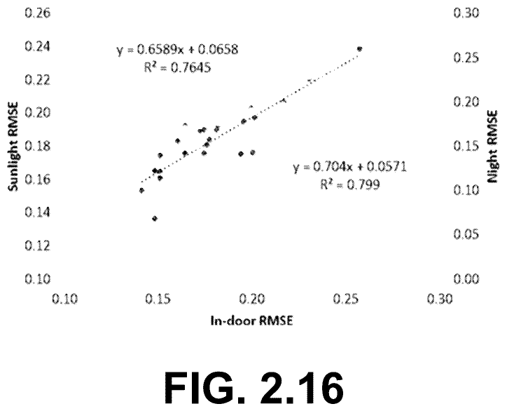

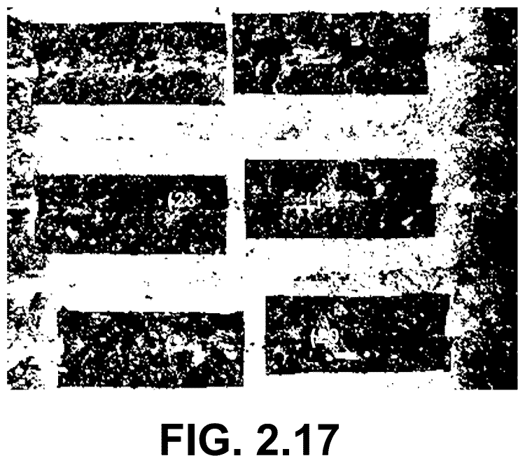

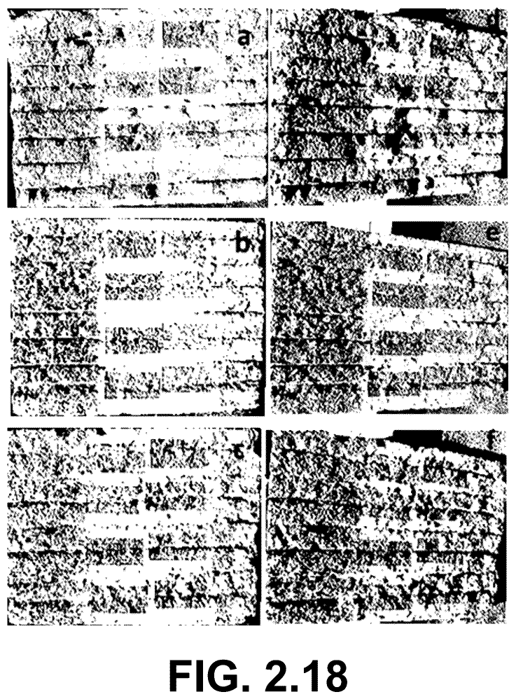

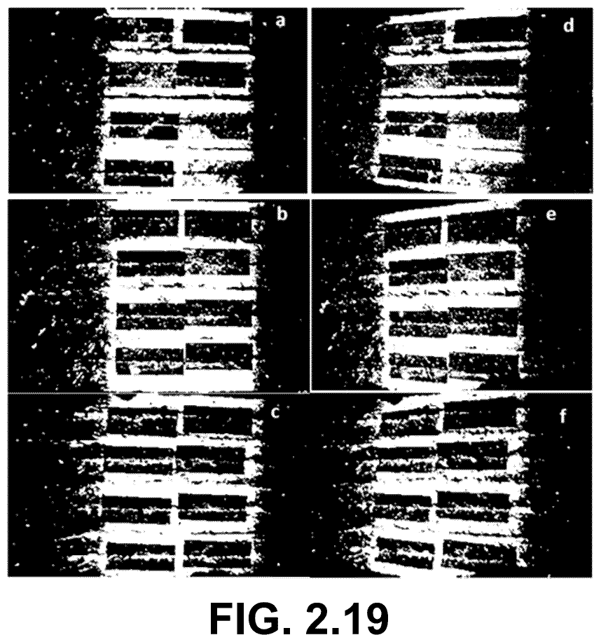

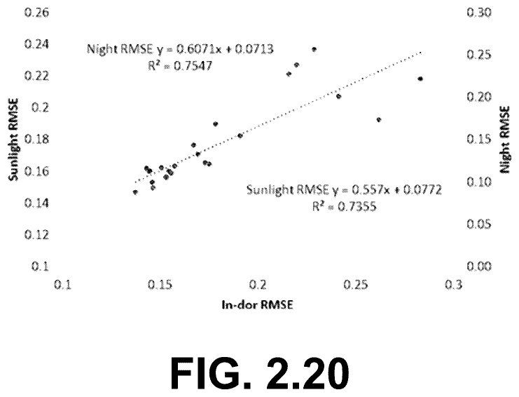

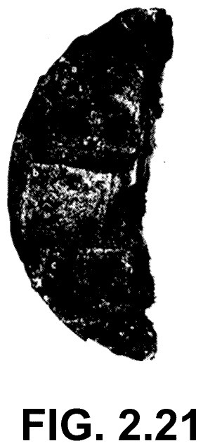

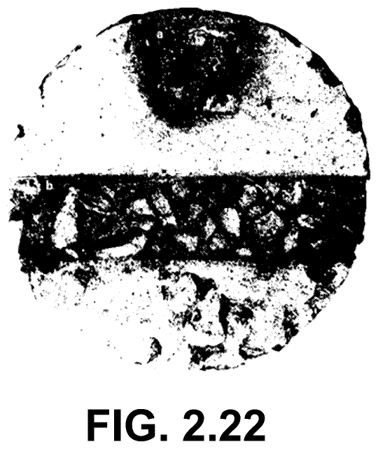

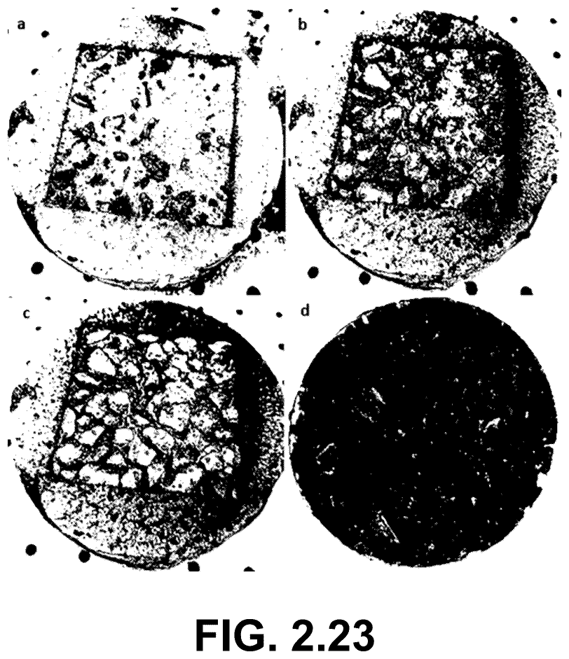

The concrete samples were made from QUIKRETE Concrete Mix purchased from the Home Depot. The concrete texturing was created manually as shown in FIG. 1a. After the concrete samples with texture were prepared (FIG. 2.1a), three types of concrete pavement stripes, i.e., thermo by truck, hot tape, and paint were covered on the sample surfaces by Stripe-A-Zone, Inc, Texas, USA, and the samples were cut into a size of 6-in×9-in (15-cm×23-cm), as shown in FIGS. 2.1b, c, and d, respectively.

This study is focused on concrete as a substrate. Previous studies have shown that no damages occurred in mortar specimens with high porosity and low energy irradiation (Sanjeevan and Klemm 2005); in addition, stripe removal on a concrete substrate is suggested to be carried out on dry surfaces when is possible. When the laser is applied, pop-out and cracking occurred on the stripe surface dueto the rapid increase in temperature.

There are no comprehensive analyses of the effect of temperature on the stripe and concrete materials due to laser scanning. However, the thermo by truck would start to melt over 150° C. and evaporate as temperatures exceed 200° C. The damage to the substrate material can be eliminated by applying optimum operational laser parameters without external distraction during the stripe removal process (Han et al., 2017). Ordinary Portland Cement (OPC) concrete includes 70% of CaO—SiO₂—(H2O) gel, 20% of Ca (OH)₂, ettringite (CaO·Al₂O₃·SiO₂·12(H₂O)), calcium aluminate monosulfate hydrated (4CaO·Al₂O₃·13(H₂O)), etc. Dehydration starts when heating the stripe surface and water would evaporate in a few seconds at 200° C. The hydrated chemical bonds are broken down at over 300° C. and completely broken down at over 500° C. (Sanjeevan and Klemm 2005). If laser parameters are selected correctly, the high temperature usually does not affect the depth of the concrete due to its low thermal conductivity. Thus, the heat energy may not damage the concrete substrate when high temperature is applied on the stripe on the concrete surface for short time.

### Comparisons of Image Grayscales

To quantitatively analyze images, Grayscale images containing a range of gray tones can be utilized to compare sets of images (a reference and a test image) pixel by pixel from white to black, for a better representation of images. A MATLAB program was developed for calculating the average grayscale difference between the laser-removed pavement surfaces and the original pavement (as a control). Three comparison errors, i.e., RMSE, MSE, and MAE, were calculated using Eqs. 2.1-2.3.

Root Mean Squared Error (RMSE) assumes that the grayscale errors of n samples are estimated as (eᵢ, i=1, 2, . . . , n), which does not consider the uncertainties brought in by observation errors or the method used to compare modeling and observation results. RMSE is presented as,

$$\\ \begin{matrix}R M S E = \sqrt{\frac{1}{n} {\sum }_{i = 1}^{n} {e}_{i}^{{}^{} 2}} & Eq . 2.1\end{matrix}$$

Mean squared error (MSE): If a vector of n predictions is generated from a sample that has n data points on all variables, and Y is the vector of experimental values of the variable being predicted, with Ŷ being the predicted values (e.g., as from a least-squares fit), then the MSE of the predictor is calculated as follows:

$$\\ \begin{matrix}M S E = \frac{1}{n} {\sum }_{i = 1}^{n} {( {Y}_{i} - {\hat{Y}}_{i} )}^{2} & Eq . 2.2\end{matrix}$$

Mean absolute error (MAE) is a measure of errors between paired observations expressing the same phenomenon. Y versus X include comparisons of predicted values versus experimental values. MAE is estimated as:

$$\\ \begin{matrix}M A E = \frac{{\sum }_{i = 1}^{n} \vert {y}_{i} - {x}_{i} \vert}{n} = \frac{{\sum }_{i = 1}^{n} \vert {e}_{i} \vert}{n} & Eq . 2.3\end{matrix}$$

Thus, MAE is an arithmetic average of the absolute errors |eᵢ|=|yᵢ−xᵢ|, where yᵢ is the prediction and xᵢ the experimental values.

### Experimental Setup and Image Grayscales Comparison Implementation

FIG. 2.2 shows the IPG Laser GmbH (Model: YLP-OLRC) used in this study, including a.

sample, b. pressured air knife, c. laser scan head, d. laser, e. water cooler, f. fume extractor. The laser is a maintenance-free pulsed fiber laser with a wavelength of 1060 nm, water cooled. The laser scan head made with a galvo-mirror was used to scan the laser beam at a selected speed. The fume absorber was used to collect fume from the ablation process and the air knife was used to protect the optics of the scanner from the debris. The laser and the experimental setup used are depicted in FIG. 2.2. In addition, to avoid damages to the scanner's lens, due to glass beads expelled during the process, two air-knives were used at ˜130 psi.

It is important to select appropriate laser parameters in a laser removal process (Sanjeevan & Klemm, 2005). Several parameters must be considered during the coating removal process, which are laser wavelength (λ), laser fluence (F), pulse width (PW), and repetition rate (RR) (Brygo et al., 2006). Inappropriate selection of laser parameters may lead to overexposure, which may result in substrate damage due to the high energy density of the laser beam, whereas underexposure can leave residual contaminations on the surface of the substrate (Li et al. 2018).

Laser radiation absorptivity into the coating material depends on the wavelength for the CW laser beam, but not for the pulsed laser beam. There is no clear relationship between laser radiation absorption and its wavelength (Siggs, 2010). However, a study at the University of Southern California revealed that by increasing the laser's wavelength, the marking would be left after the laser removal.

In this project, the laser operating parameters used were Average power (VV), Pulse frequency (kHz), Pulse width (PW, ns), Scanning velocity (mm/s), and Fill pitch (FP, mm). The laser wavelength was fixed at 1.064 μm. During the scanning tests, it was found that the number of changing scan directions (vertical/parallel) notably affects the removal efficiency. Thus, an input variable of the Number of changing scan directions (Number) was used in the analysis. The greater standoff distance of the 254-mm optic with a 120-psi air knife to protect the lens seemed to successfully mitigate the lens damage due to the spherical beads effect and be still effective for the stripe removal.

To improve the removal efficiency, this project was aimed at minimizing the scanning time with satisfactory Grayscale errors between the stripe removed zone and control one. The highest average laser power of 200 W with a pulse width of 60 ns and pulse frequency of 20-30 kHz was utilized during the removal of thermo by truck stripe. The galvo-mirror, which scans the laser beam used for removing the stripes, was set to 2000 mm/sec. The laser beam was positioned perpendicular to the sample's surface.

An area of 0.8×2 in (20×50 mm) was removed by the laser scan for each test as shown in FIG. 2.3. FIG. 2.3a shows the sample with the original stripe, FIG. 2.3b presents the sample with three rectangles were removed, and FIG. 2.3c illustrates eight removed rectangles.

Photos with different camera angles (a. 90 deg., b. 45 deg., and c. 20 deg.) are presented in FIG. 2.4. The grayscale comparison procedures are as follows:

As shown in FIG. 2.5, a rectangle was cut from the stripe removed area (a in FIG. 2.5) and another rectangle was cut from the control area (b in FIG. 2.5). Both cut images were saved to a temporary file in the MATLAB program. Then the grayscale tones on the images of the original pavement area before striping and the stripe-removed area were compared. Three errors between the two images, i.e., Root Mean Squared Error (RMSE), Mean squared error (MSE) and Mean absolute error (MAE) were calculated.

### Concrete Samples' Test Results and Discussion

In this project, the targets of the experiments were to minimize stripe removal time with acceptable removal quality, i.e., the small grayscale error between the stripe-removal zone and control one as shown in FIG. 2.5. The laser removals of three types (thermo by truck, hot tape, and paint) of stripes from concrete pavement were investigated.

### Laser Removal of Thermo by Truck Stripes

Firstly, the experiments of stripe removals were carried out in the laboratory. Since the laser power is directly related to the stripe removal time, the highest power of 200 W for the laser was applied to achieve the fastest removal efficiency. The Pulse frequency of 30 kHz and the Pulse width of 30 ns were used for the removal of thermo by truck stripe. During the experiments, it was found that the number of changing scan directions (vertical/parallel) significantly affect the removal efficiency, therefore, the number of changing vertical/parallel directions (Number) was considered as an input variable during the analysis. In summary, three parameters, i.e., Scanning speed (mm/s), Fill pitch (mm), and Number of changing scan directions were used in the analysis. Thirty-two laser scan runs were carried out and three errors (RMSE, MSE, and MAE) between the stripe removed zone and control ones were calculated and are presented in Table 2.1.

The thickness of the white thermo by truck stripe is 100 mil (2.54 mm). The smaller error indicates better removal quality; most samples have satisfactory removal results based on close visual examinations.

TABLE 2.1
Laser testing parameters for removing thermoplastic stripe on concrete (Power = 200 w,
Pulse frequency = 30 kHz, Pulse width = 30 ns, and # of passes = 2-10)

| | | | # of | | | | | |
|---|---|---|---|---|---|---|---|---|
| | Scanning | Fill | changing | | | | | |
| | speed | pitch | scan | Time | | | | Average |
| No. | (mm/s) | (mm) | direction | (s) | RMSE | MSE | MAE | Error |
| 1 | 5000 | 0.3 | 2 | 31.8 | 0.1788 | 0.027 | 0.1338 | 0.1132 |
| 2 | 2000 | 0.3 | 2 | 45.8 | 0.1689 | 0.085 | 0.1302 | 0.1280 |
| 3 | 6000 | 0.3 | 2 | 36 | 0.1661 | 0.0213 | 0.123 | 0.1035 |
| 4 | 6000 | 0.2 | 2 | 42 | 0.1686 | 0.0248 | 0.1304 | 0.1079 |
| 5 | 6000 | 0.2 | 2 | 19 | 0.1384 | 0.0395 | 0.1798 | 0.1192 |
| 6 | 8000 | 0.2 | 2 | 5.16 | 0.2128 | 0.0372 | 0.1839 | 0.1446 |
| 7 | 8000 | 0.3 | 2 | 3.78 | 0.1455 | 0.0122 | 0.1874 | 0.1150 |
| 8 | 8000 | 0.45 | 10 | 2.97 | 0.1566 | 0.045 | 0.127 | 0.1095 |
| 9 | 8000 | 0.45 | 10 | 2.66 | 0.1523 | 0.0314 | 0.116 | 0.0999 |
| 10 | 8000 | 0.45 | 8 | 2.49 | 0.1788 | 0.0378 | 0.1248 | 0.1138 |
| 11 | 8000 | 0.45 | 6 | 2.97 | 0.1802 | 0.04969 | 0.1407 | 0.1235 |
| 12 | 9800 | 0.3 | 3 | 2.72 | 0.1947 | 0.0571 | 0.1737 | 0.1418 |
| 13 | 9000 | 0.2 | 2 | 12 | 0.2988 | 0.0878 | 0.2148 | 0.2005 |
| 14 | 10000 | 0.5 | 2 | 7.9 | 0.1921 | 0.0796 | 0.1705 | 0.1474 |
| 15 | 10000 | 0.3 | 2 | 4.55 | 0.1954 | 0.0778 | 0.1494 | 0.1409 |
| 16 | 9000 | 0.45 | 6 | 2.84 | 0.1771 | 0.0471 | 0.1157 | 0.1133 |
| 17 | 9000 | 0.3 | 6 | 3.36 | 0.1601 | 0.0601 | 0.1491 | 0.1231 |
| 18 | 9000 | 0.5 | 8 | 2.33 | 0.1902 | 0.0485 | 0.1491 | 0.1293 |
| 19 | 9000 | 0.3 | 8 | 2.97 | 0.1507 | 0.0228 | 0.1259 | 0.0998 |
| 20 | 9000 | 0.2 | 8 | 5.01 | 0.2177 | 0.0313 | 0.1429 | 0.1306 |
| 21 | 9000 | 0.4 | 8 | 6.6 | 0.1749 | 0.038 | 0.1426 | 0.1185 |
| 22 | 10000 | 0.3 | 8 | 4.63 | 0.1714 | 0.0348 | 0.1415 | 0.1159 |
| 23 | 8000 | 0.3 | 8 | 5.88 | 0.1805 | 0.0527 | 0.1522 | 0.1285 |
| 24 | 1000 | 0.8 | 4 | 15.22 | 0.2386 | 0.0395 | 0.1833 | 0.1538 |
| 25 | 1000 | 0.8 | 6 | 11.33 | 0.1999 | 0.04 | 0.1606 | 0.1335 |
| 26 | 3000 | 0.7 | 5 | 17.34 | 0.2167 | 0.0588 | 0.1915 | 0.1557 |
| 27 | 7000 | 0.5 | 1 | 14.22 | 0.2678 | 0.0683 | 0.2281 | 0.1881 |
| 28 | 4000 | 0.5 | 3 | 13.01 | 0.2108 | 0.0478 | 0.1348 | 0.1311 |
| 29 | 3000 | 0.7 | 1 | 10.24 | 0.2688 | 0.0778 | 0.1948 | 0.1805 |
| 31 | 7000 | 0.6 | 4 | 12.63 | 0.1678 | 0.0353 | 0.1381 | 0.1137 |
| 31 | 5000 | 0.7 | 3 | 10.33 | 0.2378 | 0.0553 | 0.1981 | 0.1637 |
| 32 | 2000 | 0.9 | 1 | 15.66 | 0.2678 | 0.08653 | 0.2181 | 0.1908 |

As an example, the photo of the thermo by truck stripe removal Sample #1 is shown in FIG. 2.6. Scans (2, 3, 5, and 7) have RMSE errors of 0.1689, 0.1661, 0.1348, and 0.1455, respectively, which achieved satisfied scan qualities.

To explore the relationship between target variables and input variables, the regression models were applied in this study. Software of IBM SPSS Statistics 26 was used for the regressions of the data listed in Table 2.1.

### Linear Regression Analysis

Firstly, the linear regression method was used to analyze the relationship between the three input variables and the target variable of Scan time (s). The results obtained as shown in Eq. 2.4.

S=58.393−0.004×V−39.676×FP−0.934×N Eq. 2.4

### R²=0.671

where S is the Scanning speed (laser scan velocity (mm/s)), FP is the filling pitch (mm), and Nr is the number of changing scan directions.

Scan time linear regression analysis showed that the linear regression model is significant (FIG. 2.7a ANOVA) with R²=0.671. FIG. 2.7b shows the coefficients of Eq. 2.4 and the significance of each input variable. Except for the variable of Number (Sig.=0.063, which is greater than α=0.05 as shown in FIG. 2.7b), other two variables are significant (Sigs.=0.00 and 0.00 in FIG. 2.7b). Secondly, the linear regression method was used to analyze the relationship between the three input variables and target variable of Grayscale error. The results obtained as shown in Eq. 2.5.

Grayscale error=0.107+2.66×10⁻⁶×S+0.077×FP−0.006×N Eq. 2.5

### R²=0.469

where S is the Scanning speed (laser scan velocity (mm/s)), FP is the filling pitch (mm), and N is the number of changing scan directions.

Grayscale error linear regression analysis showed that, although the linear regression model is significant (FIG. 2.8a ANOVA), R²=0.469 appeared too low. FIG. 2.8b shows coefficients of Eq. 2.5 and the significance of each input variable. Except for the variable of Scanning speed (Sig.=0.175, which is greater than α=0.05 as shown in FIG. 2.8b), other two variables are significant (Sigs.=0.05 and 0.01 in FIG. 2.8b).

### Nonlinear Regression Analysis

Since the R² values for linear regression are relatively low, nonlinear regression models were used to analyze the relationships between the target variables and the input variables for the experimental data in Table 2.1. The nonlinear regression results are as follows.

Scan time (s)=128.616−0.014×S−239.889×FP−0.981×N++2.88×10⁻⁷×V²+124.348×FP²−0.019×N²++0.016×V×FP+3.56×10^{&)}×V×N+0.669×FP×Number Eq. 2.6

### R²=0.798

Grayscale error=0.0589.66×10⁻⁶×S+0.2×FP−0.005×N++1.05×V²−0.018×FP²+0.001×N²−+1.53×10⁻⁵×V×FP−4.34×10⁻⁷×V×N−0.011×FP×N Ea. 2.7

### R²=0.604

In Eqs. 2.6 and 2.7, the S is Scanning speed (the laser scan velocity (mm/s)), FP is the filling pitch (mm), and N is the number of changing scan directions.

With the higher R² values, it was revealed that the Nonlinear regression model can describe the relationship between the two target variables and the input variables more accurately than the linear models for stripe removal. Thus, the nonlinear regression models are a better fit.

### Grayscale Comparison of Images Under Sunlight and at Night

To examine the effectiveness of the Grayscale comparison method for real road stripe removal, thermo by truck sample photos were taken under sunlight and at night, and then the RMSE errors were compared with those photos taken inside the lab. FIG. 2.9 shows the photos taken under sunlight, in which, a-c are sample photos under sunlight, d-f are photos taken with 30°. FIG. 2.10 shows that thermo by truck stripe photos taken at night, in which, a-c. sample photos at night, and d-f. photos were taken by a camera with 30°.

As an example, FIG. 2.11 shows the under-sunlight photo (a) and night photo (b) of stripe removals for thermo by truck Sample #1. Scans 2, 3, 5 and 7 indicated RMSE errors of 0.1633, 0.1594, 0.1631 and 0.1642, for sunlight photos and 0.1402, 0.1378, 0.1421, and 0.1533, respectively, for night photos.

The regression models were utilized to explore the relationships of the grayscale errors between photos taken in-door and under sunlight, and between in-door and night photos. The RMSE error comparison of in-door, under sunlight, and at night photos of thermo by truck stripe removals is shown in FIG. 2.12. The results indicated that both the photos taken under sunlight and at night have linear relationships with the RMSE errors of in-door photos. Their coefficients of correlation (R²) are acceptable.

### Thermo by Truck Stripe Removing Speed

In the lab tests, an area of 0.8×2 in (20×50 mm) thermo by truck stripe was removed by the laser scanning for each test as shown in FIG. 6.
The total removal area was 0.8×2 in=1.6 in²
According to Table 2.1, it was found that the shortest scanning time of 2.33-4 s (with the average errors smaller than 0.13) can be achieved with the following laser parameters: Pulse frequency of 30 kHz, Pulse width of 30 ns, Number of passes of 2-10, Scanning speed of 8000-9000 mm/s, Fill pitch of 0.3-0.5 mm, and Number of changing scan direction of 2-10.
Assuming optimal time, for a 4-inch stripe (100 mils in thickness), the speed removal is 1.7 ft/min (0.0193182 miles/hr). This can be improved with the current system based on the cleanness values desired and evaluated at a driving distance.

### Hot Tape Stripe Removal In-Door Examination

Firstly, the experiments of stripe removals were carried out in the laboratory. The highest power of 200 W for the laser was applied to achieve the fastest removal efficiency. The Pulse frequency of 30 kHz and Pulse width of 30 ns were used for the removal of the hot tape stripe.

Three parameters, i.e., Scanning speed (mm/s), Fill pitch (mm), and Number of changing scan directions were used in the analysis. Twenty-four laser scan runs were carried out and three errors (RMSE, MSE, and MAE) between the stripe removed zone and control ones were calculated and are presented in Table 2.2. The thickness of the white tape stripe was 140 mil (3.6 mm). The smaller average error indicates better removal quality and satisfactory removal results based on close visual examinations.

TABLE 2.2
Laser testing parameters for removing hot tape stripe on concrete (Power = 200 W,
Pulse frequency = 30 kHz, Pulse width = 30 ns, # of passes = 2-3)

| | | | # of | | | | | |
|---|---|---|---|---|---|---|---|---|
| | Scanning | Fill | changing | | | | | |
| | speed | pitch | scan | Time | | | | Average |
| No. | (mm/s) | (mm) | direction | (s) | RMSE | MSE | MAE | Error |
| 1 | 1000 | 0.3 | 12 | 125.1 | 0.1955 | 0.0482 | 0.1624 | 0.1354 |
| 2 | 1000 | 0.3 | 12 | 130.2 | 0.1762 | 0.0315 | 0.1381 | 0.1153 |
| 3 | 1000 | 0.2 | 12 | 141.3 | 0.1641 | 0.0219 | 0.1194 | 0.1018 |
| 4 | 3000 | 0.2 | 12 | 65.2 | 0.2166 | 0.0469 | 0.1732 | 0.1456 |
| 5 | 2000 | 0.2 | 12 | 96.5 | 0.1941 | 0.0377 | 0.1586 | 0.1301 |
| 6 | 1000 | 0.2 | 12 | 145.2 | 0.1481 | 0.0219 | 0.1173 | 0.0958 |
| 7 | 1000 | 0.2 | 10 | 122.6 | 0.1511 | 0.0228 | 0.1216 | 0.0985 |
| 8 | 1000 | 0.3 | 4 | 105.9 | 0.1743 | 0.0304 | 0.1418 | 0.1155 |
| 9 | 1000 | 0.2 | 6 | 90.1 | 0.2116 | 0.0448 | 0.1683 | 0.1416 |
| 10 | 500 | 0.2 | 2 | 157.7 | 0.1924 | 0.037 | 0.1506 | 0.1267 |
| 11 | 1000 | 0.2 | 6 | 62 | 0.2078 | 0.0482 | 0.1638 | 0.1399 |
| 12 | 1000 | 0.2 | 8 | 84 | 0.1994 | 0.0458 | 0.1671 | 0.1065 |
| 13 | 1000 | 0.2 | 10 | 106.1 | 0.1818 | 0.0331 | 0.1449 | 0.1199 |
| 14 | 1000 | 0.3 | 10 | 102.6 | 0.1723 | 0.0297 | 0.1383 | 0.1134 |
| 15 | 1000 | 0.3 | 10 | 102.6 | 0.1644 | 0.0307 | 0.1314 | 0.1088 |
| 16 | 1000 | 0.3 | 10 | 102.6 | 0.2301 | 0.0529 | 0.1885 | 0.1572 |
| 17 | 1000 | 0.2 | 10 | 128.6 | 0.177 | 0.0313 | 0.1393 | 0.1159 |
| 18 | 1000 | 0.2 | 10 | 81.7 | 0.1811 | 0.0328 | 0.1467 | 0.1202 |
| 19 | 1000 | 0.2 | 10 | 120.3 | 0.1412 | 0.0199 | 0.1133 | 0.0915 |
| 20 | 1000 | 0.2 | 8 | 127.9 | 0.1511 | 0.0228 | 0.1217 | 0.0985 |
| 21 | 1000 | 0.2 | 6 | 95.2 | 0.1605 | 0.0257 | 0.1254 | 0.1039 |
| 22 | 2000 | 0.2 | 6 | 76.5 | 0.1605 | 0.0257 | 0.1254 | 0.1039 |
| 23 | 4000 | 0.2 | 6 | 70.3 | 0.2015 | 0.0657 | 0.1692 | 0.1455 |
| 24 | 6000 | 0.2 | 6 | 65.3 | 0.2305 | 0.0857 | 0.1843 | 0.1668 |

During the analysis, we used the highest power of 200 W for the laser, and Pulse Frequency of 30 kHz, and Pulse width of 30 ns:
To improve the removal efficiency, we focused on minimizing the scan time. We found that the number of changing scan direction (vertical/parallel) significantly affect the removal efficiency.
Three parameters, i.e., Scanning speed (mm/s), Fill pitch (mm), and Number of changing scan directions were used in the analysis.

Scans (22) and (23) with average errors of 0.0915 and 0.0985, respectively, removed all stripes and achieved satisfying qualities. We completed 24 laboratory tests for removing hot tape stripes (FIG. 2.13).

The thickness of the white-hot tape stripe was 140 mil (3.6 mm). The smaller average error indicates better removal quality and satisfactory removal results based on visual examinations.

According to the experimental data, the following equation was obtained by nonlinear regression. Software of IBM SPSS Statistics 26 was used for the regressions

Scan time(s)=22.18+0.077×S+1187.723×FP−23.823×N++2.69E−06×V²−1624.593×FP²+2.161×N²−+0.372×V×FP−0.004×V×N−11.397×FP×N Eq. 2.8

### R²=0.776

Error=8.507+1.00×10⁻³×S−71.68×FP−0.015×Number−+1.80×10^{-9×}V²+148.92×FP²−2.30×10⁻⁵×N²−+3.00×10^{-3×}V×FP+1.06×10⁻⁶×V×N+0.052×FP×N Eq. 2.9

### R²=0.716

In Eqs. 2.8 and 2.9, Scanning speed is the laser scan velocity (mm/s), FP is the filling pitch (mm), and Number is the number of changing scan directions.

Hot Tape Stripe Removal Examination under Sunlight and at Night

To examine the effectiveness of the Grayscale comparison method for real road tape stripe removal, tape sample photos were taken under sunlight and at night, then the RMSE errors were compared with those photos taken inside the lab. FIG. 2.14 shows the tape stripe photos taken under sunlight, in which, a-c are sample photos under sunlight, d-f are photos taken by a camera with 30°. FIG. 2.15 shows the tape stripe photos taken at night, in which, a-c are sample photos at night, d-f are photos taken by a camera with 30°.

The regression models were utilized to explore the relationships of the grayscale errors between photos taken in-door and under sunlight, and between in-door and night photos. The RMSE error comparison of in-door, under sunlight, and at night photos of hot tape stripe removals is shown in FIG. 2.16. The results indicated that both the photos taken under sunlight and at night have linear relationships with the RMSE errors of in-door photos. Their coefficients of correlation (R²) are acceptable.

### Hot Tape Stripe Removing Speed

In the lab tests, an area of 0.8×2 in (20×50 mm) tape stripe was removed by laser for each test as shown in FIG. 2.13. The total removal area was 0.8×2 in=1.6 in²
According to Table 2.2, it was found that the shortest scanning time of 62-90 s (with the average errors smaller than 0.15) can be achieved with the following laser parameters: Pulse frequency of 30 kHz, Pulse width of 30 ns, Number of passes of 2-3, Scanning speed of 1000-3000 mm/s, Fill pitch of 0.2 mm, and Number of changing scan direction of 6-10.

Assuming optimal time, for a 4-inch stripe (140 mils in thickness), the speed removal is 0.065 ft/min (0.0007386 miles/hr). This can be improved with the current system based on the cleanness values desired and evaluated at a driving distance.

### Paint Stripe Removal In-Door Examination

We completed 24 laboratory tests for removing paint stripes as shown in Table 2.3. The thickness of the white paint stripe was about 40 mil (1 mm). The smaller average error indicates better removal quality and satisfactory removal results based on close visual examinations.

TABLE 2.3
Laser testing parameters for removing paint stripe on concrete (Power = 200
w, Pulse frequency = 30 kHz and # of passes = 3)

| | | | | # of | | | | | |
|---|---|---|---|---|---|---|---|---|---|
| | | | Fill | changing | | | | | |
| | Pulse | Velocity | pitch | scan | Time | | | | Average |
| No. | width (ns) | (mm/s) | (mm) | direction | (s) | RMSE | MSE | MAE | Error |
| 1 | 30 | 1000 | 0.2 | 2 | 30 | 0.173 | 0.0335 | 0.1315 | 0.1127 |
| 2 | 30 | 1000 | 0.3 | 2 | 19.6 | 0.2618 | 0.0684 | 0.2221 | 0.1453 |
| 3 | 30 | 2000 | 0.2 | 2 | 10.7 | 0.2832 | 0.0802 | 0.2613 | 0.2082 |
| 4 | 60 | 2000 | 0.2 | 2 | 10.6 | 0.2411 | 0.0581 | 0.1614 | 0.1535 |
| 5 | 60 | 2000 | 0.2 | 4 | 30.6 | 0.1573 | 0.0247 | 0.1233 | 0.1018 |
| 6 | 120 | 2000 | 0.2 | 4 | 30.6 | 0.144 | 0.0207 | 0.113 | 0.0926 |
| 7 | 240 | 4000 | 0.2 | 6 | 15 | 0.2197 | 0.042 | 0.1677 | 0.1431 |
| 8 | 240 | 1000 | 0.45 | 4 | 44.7 | 0.2286 | 0.0522 | 0.1992 | 0.1600 |
| 9 | 60 | 4000 | 0.3 | 4 | 27.6 | 0.1694 | 0.0287 | 0.1479 | 0.1153 |
| 10 | 60 | 4000 | 0.3 | 6 | 13 | 0.2158 | 0.0466 | 0.1695 | 0.1440 |
| 11 | 60 | 4000 | 0.2 | 6 | 16.9 | 0.191 | 0.0365 | 0.1547 | 0.1274 |
| 12 | 60 | 4000 | 0.2 | 8 | 26.3 | 0.1671 | 0.0279 | 0.1313 | 0.1088 |
| 13 | 60 | 4000 | 0.3 | 8 | 30.7 | 0.1544 | 0.0238 | 0.1193 | 0.0992 |
| 14 | 60 | 2800 | 0.3 | 6 | 29 | 0.1506 | 0.0231 | 0.1151 | 0.0963 |
| 15 | 60 | 3300 | 0.2 | 6 | 32.2 | 0.1531 | 0.025 | 0.1213 | 0.0998 |
| 16 | 60 | 3000 | 0.2 | 6 | 31.7 | 0.1554 | 0.0242 | 0.1225 | 0.1007 |
| 17 | 60 | 5000 | 0.2 | 10 | 35.5 | 0.1373 | 0.0189 | 0.1099 | 0.0887 |
| 18 | 60 | 5000 | 0.3 | 10 | 34.2 | 0.146 | 0.0213 | 0.1145 | 0.0939 |
| 19 | 60 | 5000 | 0.4 | 8 | 23.5 | 0.1449 | 0.021 | 0.1167 | 0.0942 |
| 20 | 60 | 2000 | 0.4 | 6 | 22.7 | 0.1532 | 0.0235 | 0.1188 | 0.0985 |
| 21 | 60 | 2000 | 0.45 | 8 | 30.2 | 0.175 | 0.0306 | 0.1424 | 0.1160 |
| 22 | 30 | 2000 | 0.45 | 8 | 30.2 | 0.1784 | 0.0315 | 0.1477 | 0.1192 |
| 23 | 30 | 6000 | 0.3 | 12 | 24.1 | 0.1428 | 0.0204 | 0.1136 | 0.0923 |
| 24 | 30 | 8000 | 0.3 | 16 | 25.9 | 0.1462 | 0.0214 | 0.1177 | 0.0951 |

FIG. 2,17 shows that Scans (19), (20), (23), and (24) with average errors of 0.0942, 0.0985, 0.0923, and 0.0951, respectively, removed all stripes and achieved satisfying qualities.

Four parameters, i.e., Pules width (PW, ns), Scanning speed (mm/s), Fill pitch (FP, mm), and Number of changing scan directions were used in the regression analysis. According to the experimental data, the following equations were obtained by nonlinear regressions

Scan time(s)=47.249−0.269×PW−0.051×S−32.19×FP++25.375×N+×PW2−7.60×10⁻⁶×V²−+282.212×FP²+1.724×N²+4.52×10⁻⁵×PW×V++1.22×PW×FP−0.018×PW×N+0.111×V×FP−+0.007×V×N−49.679×FP×N Eq. 2.10

### R²=0.867

Error=0.113+0×PW+0×S+0.115×FP−0.096×N++5.16×10⁻⁶×PW²−1.52×10⁻⁸×V²+0.654×FP²−+0.001×N²−7.65×10⁻⁷×PW×V−0.005×PW×FP++0×PW×N+0×V×FP+9.94×10⁻⁶×V×N+0.121×FP×N Eq. 2.11

### R²=0.913

In Eqs. 2.10 and 2.11, PW is Pulse width (ns), S is the Scanning speed (the laser scan velocity (mm/s)), FP is the filling pitch (mm), and Number is the number of changing scan directions.

### Paint Stripe Removal Examinations Under Sunlight and at Night

To examine the effectiveness of the Grayscale comparison method for real road paint stripe removal, paint sample photos were taken under sunlight and at night, then the RMSE errors were compared with those photos taken inside the lab. FIG. 2.18 shows the paint stripe photos taken under sunlight, in which, a-c are sample photos under sunlight, d-f are photos taken by a camera with 30°. FIG. 2.19 shows the paint stripe photos taken at night, in which, a-c are sample photos at night, d-f are photos taken by a camera with 30°.

The regression models were utilized to explore the relationships of the grayscale errors between photos taken in-door and under sunlight, and between in-door and night photos. The RMSE error comparison of in-door, under sunlight, and at night photos of hot tape stripe removals is shown in FIG. 2.20. The results indicated that both the photos taken under sunlight and at night have linear relationships with the RMSE errors of in-door photos. Their coefficients of correlation (R²) are acceptable.

### Paint Stripe Removing Speed

In the lab tests, an area of 0.8×2 in (20×50 mm) paint stripe was removed by laser for each test as shown in FIG. 2.17. The total removal area was 0.8×2 in=1.6 in²
According to Table 2.3, it was found that the shortest scanning time of 13-36 s (with the average errors smaller than 0.13) can be achieved with the following laser parameters: Pulse frequency of 30 kHz, Pulse width of 30-120 ns, Number of passes of 2-3, Scanning speed of 2000-8000 mm/s, Fill pitch of 0.2-0.45 mm, and Number of changing scan direction of 4-12.
The speed of removing the 4-in tape stripe is 0.31 ft/min (0.0035227 miles/hr). This can be improved with the current system based on the cleanness values desired and evaluated at a driving distance.

### Projected Removal Speed Using a 1000 W Output Laser

The fluence (energy deposited per unit of area) generated by the 200 W average power laser used in this study can be increased when using a more powerful laser such as a laser with an average output power of 1000 W. Although the initial cost of the apparatus can be higher (roughly 70%), the removal rate of the ablated material can increase. The quantification of the ablation rate depends by several parameters. However, assuming same laser's characteristics (e.g. wavelength, FWHM, etc.) and a linear relationship between the removal speed and the fluence (constant removal rate), it can be projected to have a removal speed of ˜53 ft/min (0.60 miles/hr) for thermoplastic stripes. For the hot tape stripe, the removal speed is projected to be 44.6 ft/min (0.51 miles/hr) while for the paint stripe the removal speed would be 158 ft/min (1.79 miles/hr). These removal speeds are comparable if not higher than other methods such as grinding and water blasting (see Pike et al. (2013)). To be notice that the calculations made are based on the removal rate of plastics materials found (˜8 mm³/W min, where W is the average power of the laser in watts) in Hodgson et al. (2019)). The calculated removal speed for rate could be overestimated and further research would be needed to evaluate the removal rate.

Preliminary Test and Results of Laser Removal of Paint Stripes from Asphalt

We completed preliminary six lab tests for removing paint stripes from asphalt. The asphalt cores were received from the TxDOT Fort Worth Material Science Lab. Unfortunately, the exact composition was not known. The thickness of the white paint stripe was less than 40 mil (<1 mm). The sizes of scanned zones and parameters used in preliminary tests are presented in Table 2.4.

TABLE 2.4
Laser parameters of removing paint stripe from asphalt

| | | | Pulse | Pulse | | Fill | | # of | | |
|---|---|---|---|---|---|---|---|---|---|---|
| | Size | Power | Freq | width | Velocity | pitch | # of | change | Time | Ave. |
| No. | (mm × mm) | (W) | (kHz) | (ns) | (mm/s) | (mm) | Passes | direction | (s) | error |
| 1a | 20 × 20 | 200 | 200 | 30 | 9000 | 0.1 | 20 | 2 | 24 | 0.1575 |
| 1b | 20 × 20 | 100 | 200 | 30 | 9000 | 0.1 | 20 | 2 | 24 | 0.1629 |
| 1c | 20 × 20 | 200 | 200 | 30 | 9000 | 0.1 | 30 | 2 | 38 | 0.1284 |
| 2a | 20 × 50 | 200 | 30 | 30 | 2000 | 0.1 | 5 | 2 | 16 | 0.1208 |
| 2b | 20 × 100 | 200 | 30 | 30 | 4000 | 0.1 | 10 | 3 | 58 | 0.1681 |
| 3a | 60 × 60 | 200 | 30 | 30 | 6000 | 0.1 | 6 | 4 | 82 | 0.4194 |
| 3b | 60 × 60 | 200 | 30 | 30 | 6000 | 0.1 | 6 | 4 | 82 | 0.2695 |
| 3c | 60 × 60 | 200 | 30 | 30 | 6000 | 0.1 | 6 | 4 | 82 | 0.2928 |

The scanned results are presented in FIGS. 2.21, 2.22, and 2.23. FIG. 2.21 1a-c shows the removed white paint stripe from Sample 1 with a scan area of 1-in×1-in. FIG. 2.21 1a shows that the most stripe was removed. FIG. 2.21 1b shows that the small portion of the stripe was removed. FIG. 2.21 1c illustrates that all the stripes were removed, but meanwhile, some asphalt was melted out as well, exposing the aggregates

FIG. 2.22 1a shows that all paint stripe was removed from a 1″×1″ square portion of the core, but some aggregates were shown. FIG. 2.22 1b displays that the laser removed some stripe and melted the superficial layer of the asphalt in a 1″×4″ rectangular, showing coarse aggregates.

FIG. 2.23 shows the removal process of paint stripe of 2.5″×2.5″ square from asphalt by multiple scans. The first scan only removed a small portion of the white stripe as shown in FIG. 2.23 1a. The second scan removed most of the stripe as shown in FIG. 2.23 1b. The third scan removed the whole white stripe but melted the superficial layer of the asphalt, showing coarse aggregates (see FIG. 2.23 1c). FIG. 2.23 1d shows the control sample before the laser removal process.

The results of the laser removal for the paint stripe from the asphalt revealed that the major problem is that the melting temperature for asphalt is low (54° C. or 12° F.), which causes the asphalt to be melted before the surface paint is totally removed by the heating and the evaporation of the paint. We tried the laser scan with temperatures below the melting point of asphalt to remove the stripe, but it seems that the temperatures lower than the asphalt melting temperatures are not possible to successfully remove the white stripe on asphalt. Additional investigation is needed to minimize this issue.

### SUMMARY

In this work, the influences of laser irradiation parameters on the removal effectiveness of three types of stripes (thermo by truck, hot tape, and paint) from concrete pavements and one type of stripe (paint) from asphalt were experimentally investigated. The removal effectiveness included the removal time and quality, in which, the removal quality was evaluated in close proximity by comparing errors of Grayscale tones on the images between the original pavement area before striping and the stripe-removed area. A MATLAB program for calculating the average grayscale difference between the laser-removed surfaces and the control was developed. The laser irradiation parameters included the average laser power (Watts), pulse frequency (kHz), pulse width (ns), scanning speed (mm/s), fill pitch (mm), number of passes, and number of changing scan directions. The targets were to minimize the total scan time(s) and best scan quality (smallest errors of Grayscale gray tones)

The results showed that the laser removal of stripes from concrete was highly successful. Among the three stripes, the thermo by truck stripe was the fastest one to be removed by laser, followed by paint stripes, while the hot tape stripes (higher thickness) were the slowest one. Moreover, although paint stripes were removed faster than hot tape stripes, due to the very low thickness, they resulted to be more difficult to be removed due probably to the reflectivity of the material at the wavelength of the laser used. According to the small lab-scale experiments (removing an area of 2-in×0.8-in, i.e., 50-mm×20-mm, each laser scan), it was found that the removing speed for 4-in width stripe can be 1.7 ft/min (0.0193182 miles/hr) for the thermo by truck stripe, 0.065 ft/min (0.0007386 miles/hr) for the paint stripe, and 0.31 ft/min (0.0035227 miles/hr) for the hot tape stripe. These removal speeds can be greatly improved if we consider higher distances for evaluating the cleanness. This will be checked during the field tests. Also, the removal speeds can be increased by preparing the surface with some mechanical technique (to remove exposed glass beads).

The preliminary experiments for laser removal of paint stripes from asphalt pavement showed that the asphalt surface was melted with the stripe removal. We will consult experts in asphalt materials to figure out the type and properties of the asphalt used and further investigate stripe removal on asphalt with the current laser equipment.

To examine the effectiveness of the Grayscale comparison method for real road stripe removal, we took stripe sample photos under sunlight and at night, and compared their RMSEs with those photos taken inside the lab. The results indicated that the Grayscale errors of under sunlight and at night photos are linearly related to that of in-door photos with acceptable correlation coefficients (R²).

It should be kept in mind that this study was carried out at a laboratory scale with a 200 W laser, a small scanning zone, and a limited number of replications. To meet the stripe removal speed requirements in the real case, one possible solution would be to increase the output power of the laser (e.g., over 1000-W) and its frequency (>200 KHz), which can significantly increase the removal speed for real stripe removal practice. The cost of a higher power laser (50%-70% more than the current system's cost) is certainly much smaller than water blast/grinding instrumentations. For example, assuming same laser's characteristics of the one used for these experiments but with an average power output of 1000 W, it can be projected to have a removal speed of ˜53 ft/min (0.60 miles/hr) for thermoplastic stripes, 44.6 ft/min (0.51 miles/hr) for the hot tape stripe, and 158 ft/min (1.79 miles/hr) for the paint stripe. These values are of the same magnitude of grinding and water blasting removal speeds if not higher in the case of paint.

### REFERENCES FOR EXAMPLE 2

Berg, K., and S. Johnson. Field Comparison of Five Pavement Marking Removal Technologies. Report No.

UT-08.12. Utah Department of Transportation. Salt Lake City, UT. 2009.

Cho, Y.; Kabassi, K.; Pyeon, J-H.; Choi, K.; Wang, C.; and Norton, T. 2013. Effectiveness Study of Methods for Removing Temporary Pavement Markings in Roadway Construction Zones, J. Constr. Eng. Manage., 2013, 139(3): 257-266

Cole, S. 2011. Striping business startup article-how to remove traffic or parking lot striping lines, Feb. 21, 2011, https://parkinglotstripingbusiness.com/3a-how-to-remove-traffic-or-parking-lot-striping-lines/Ellis,

Ellis, R., and Pyeon, J. (2006). “Development of improved procedures for removing temporary pavement markings during highway construction.” Proc., Transportation Research Board 85th Annual Meeting, Transportation Research Board, Washington, DC. https://www.workzonesafety.org/files/documents/database documents/Research3076.pdf

FHWA (Federal Highway Administration). (2009). Manual on uniform traffic control devices (MUTCD) for streets and highways-2009 edition.” Washington, DC, (Dec. 14, 2012), http://m utcd.fhwa. dot. gov/kno 2009r1r2.htm.

Graco 2019. Grinding and blasting are the most common technologies to remove road paint, https://www.graco.com/gb/en/products/pavement-maintenance/pavement-marking-removal/how-to-remove-road-marking-paint.html

Han, J., Cui, X., Wang, S., Feng, G., Deng, G. and Hua, R. 2017. Laser effects based optimal laser parameter identifications for paint removal from metal substrate at 1064 nm: a multi-pulse model, Journal of Modern Optics, 2017, https://doi.org/10.1080/09500340.2017.1330433

Han, J., Cui, X., Wang, S., Feng, G., Deng, G., & Hu, R. (2017). Laser effects based optimal laser parameter identifications for paint removal from metal substrate at 1064 nm: A multi-pulse model. Journal of Modern Optics, 64(19), 1947-1959.

Hodgson, N., Heming, S., Steinkopff, A., Haloui, H., & Lee, T.S. 2019. Ultrafast Laser Ablation at 1035 nm, 517 nm and 345 nm as a Function of Pulse Duration and Fluence. Lasers in Manufacturing Conference 2019.

Li, G; Gao, W; Zhang, L; Wu, X; Zhang, L; Wei, Z; Li, B; Xue, Y; Wang, J; Wang, X. 2021. The quality improvement of laser rubber removal for laminated metal valves, Optics and laser technology, 07/2021, 139: Start Page:106785, D01:10.1016/j.optlastec.2020.106785

Li, X; Zhang, Q; Zhou, X; Zhu, D; Liu, Q. 2018. The influence of nanosecond laser pulse energy density for paint removal, Optik (Stuttgart), 03/2018, Volume 156: 841-846, D01:10.1016/j.ijleo.2017.11.010

Madhukar, YK; Mullick, S; Shukla, DK; Kumar, S; Nath, AK. 2013. Effect of laser operating mode in paint removal with a fiber laser, Applied surface science, 01/2013, 264: 892-901, D01:10.1016/j.apsusc.2012.10.193

Morais, P., Gouveia, H., Apostol, 1., Damian, V., Garoi, F., lordache, 1., et al. 2010. Laser beam in the service of paintings restoration. Romanian Reports in Physics, 62(3), 678-686.

Pew, H., and Thome, J. (2000). “Laser removal of paint on pavement.” TRB/NCHRP-16, Final Rep., IDEA Program, Transportation Research Board, Washington, DC. http://onlinepubs.trb.org/onlinepubs/archive/studies/idea/finalreports/highwav/NCHRP016 FinalRort.pdf

Pike, A.M. and Miles, J.D. 2013. Effective Removal of Pavement Markings National Cooperative Highway Research Program, NCHRP Report 759, Texas A&M Transportation Institute College Station, TX, TRANSPORTATION RESEARCH BOARD, WASHINGTON, D.C. 2013, www.TRB.org

Razab, MKAA., Noor, AM., Jaafar, MS., Abdullah, NH., Suhaimi, FM., Mohamed, M., Adam, N., Yusuf, NAAN. 2018. A review of incorporating Nd: YAG laser cleaning principal in automotive industry, Journal of Radiation Research and Applied Sciences 11 (2018) 393-402, https://doi.org/10.1016/j.jrras.2018.08.002

Sanjeevan, P. and Klemm, A. J. 2005. A REVIEW OF LASER TECHNIQUE APPLICATION IN CLEANING PROCESS OF POROUS CONSTRUCTION MATERIALS, Proceedings of the 2nd

Scottish Conference for Postgraduate Researchers of the Built and Natural Environment (PRoBE) 16-17 November 2005, Glasgow Caledonian University, Glasgow, Scotland, UK

Schmidt, M.J.J; Li, L; Spencer, J.T. 2003. An investigation into the feasibility and characteristics of using a 2.5 kW high power diode laser for paint stripping, Journal of materials processing technology, 2003, 138(1): 109 — 115, D01:10.1016/50924-0136(03)00057-8

Zhang, G; Hua, X; Li, F; Zhang, Y; Shen, C; Cheng, J. 2019. Effect of laser cleaning process parameters on the surface roughness of 5754-grade aluminum alloy, International journal of advanced manufacturing technology, 12/2019, Volume 105(5): 2481-2490, DOI: 10. 1007/s00170-019-04395-6

Zhang, Y., Zhang, D., Wu, J., He, Z., Deng, X. 2017. A thermal model for nanosecond pulsed laser ablation of aluminum, AIP ADVANCES 7, 075010-1 (2017), http://dx.doi.orq/10.1063/1.4995972

Zheng, Z., Wang, C., Huang, G., Feng, W. and Liu, D. 2021. Effect of Defocused Nanosecond Laser Paint Removal on Mild Steel Substrate in Ambient Atmosphere, Materials 2021, 14, 5969, https://doi.org/10.3390/ma14205969

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

In view of the foregoing discussion, below is a description of the various embodiments of the present disclosure. It is understood that the below embodiments are not an exhaustive recitation of the possible embodiments of the present disclosure and that the other embodiments are described herein.

Embodiment 1 is a method that comprises of aligning a vehicle with a type of pavement marking on a type of pavement, the vehicle having a laser system. The method also comprises of aiming the laser system at the type of pavement marking, detecting the type of pavement marking using a sensor, detecting the type of pavement using the sensor, and setting a plurality of laser parameters based at least in part on detection of the type of pavement marking and detection of the type of pavement. The method further comprises of activating a laser system to produce a laser beam, and passing (e.g., directing the laser beam at) the laser beam over the type of pavement marking in a scan direction.

Embodiment 2 comprises of a method as set forth in embodiment 1, wherein the plurality of laser parameters includes at least one of a laser power, a laser wavelength, a laser fluence, a pulse frequency, a pulse width, a velocity, and a fill pitch.

Embodiment 3 comprises of a method as set forth in embodiment 1, further comprising of changing the scan direction to a second scan direction, and passing the laser beam over the type of pavement marking in the second scan direction.

Embodiment 4 comprises of a method as set forth in embodiment 1, further comprising of blocking the laser beam from exiting the laser system, determining a residual mark of plurality of residual marks exists, and, in response to determining a residual mark, passing the laser over the residual mark.

Embodiment 5 comprises of a method as set forth in embodiment 4, further comprising of blocking the laser beam from exiting the laser system, determining the type of pavement is free of residual marks, and, in response to determining the type of pavement is free of residual marks, blocking the laser beam from exiting the laser system.

Embodiment 6 comprises of a method as set forth in embodiment 1, further comprising of removing a plurality of glass beads from the type of pavement marking prior to activating the laser.

Embodiment 7 comprises of a method as set forth in embodiment 1, further comprising of blocking the laser beam from exiting the laser system, detecting a second type of pavement marking, and adapting the plurality of laser parameters, based at least in part on the second type of pavement marking and the type of pavement. The method further comprises of unblocking the laser beam, and passing the laser over the second type of pavement marking in a scan direction.

Embodiment 8 comprises of a method as set forth in embodiment 7, further comprising of changing the scan direction to a second scan direction, and passing the laser over the second type of pavement marking in the second scan direction.

Embodiment 9 is a method that comprises of receiving, by a laser control application, a vehicle aligned indication that a vehicle has been aligned with a type of pavement marking on a type of pavement, and sending, by the laser control application, a request to a laser system to aim a laser beam at the type of pavement marking. The method further comprises of receiving, by the laser control system, both a pavement type indication from a sensor and a pavement marking type from the sensor, and determining, by the laser control application, a plurality of laser parameters based at least in part on the pavement type indication and the pavement marking type indication. The method additionally comprises of sending, by the laser control application, a plurality of laser parameters to the laser system, an initiation request to the laser system, and a movement request to the laser system to pass the laser beam over the type of pavement marking in a scan direction.

Embodiment 10 comprises of a method as set forth in embodiment 9, wherein the plurality of laser parameters includes at least one of a laser power, a laser wavelength, a laser fluence, a pulse frequency, a pulse width, a velocity, and a fill pitch.

Embodiment 11 comprises of a method as set forth in embodiment 9, further comprising of sending, by the laser control application, both a request to the laser system to change the scan direction to a second direction and a movement request to the laser system to pass the laser beam over the type of pavement marking in the second scan direction.

Embodiment 12 comprises of a method as set forth in embodiment 9, further comprising of sending, by the laser control application, a request to the laser system to block the laser beam from exiting the laser system; receiving, from the sensor, a determination of a residual mark of a plurality of residual marks; in response to receiving a determination of a residual mark, sending, by the laser control application, a request to the laser system to unblock the laser beam; and sending, by the laser control application, a movement request to the laser system to pass the laser beam over the residual mark.

Embodiment 13 comprises of a method as set forth in embodiment 12, further comprising of sending, by the laser control application, a request to the laser system to block the laser beam from exiting the laser system; receiving, from the sensor, a determination that the type of pavement is free of residual marks; and in response to receiving a determination that the type of pavement is free of residual marks, sending, by the laser control application, a request to a user to find a next pavement marking.

Embodiment 14 comprises of a method as set forth in embodiment 9, further comprising of sending, by the laser control application, a request to the laser system to block the laser beam from exiting the laser system; receiving, by the laser control application, a second pavement marking type indication from the sensor; and determining, by the laser control application, a plurality of laser parameters based at least in part on the second pavement marking type indication. The method further comprises of sending, by the laser control application, both a request to the laser system to unblock the laser beam, and a movement request to the laser system to pass the laser beam over the type of pavement marking in a scan direction.

Embodiment 15 comprises of a method as set forth in embodiment 14, further comprising of sending, by the laser control application, both a request to the laser system to change the scan direction to a second scan direction, a movement request to the laser system to pass the laser beam over the type of pavement marking in the second scan direction.

Embodiment 16 is a system for removing pavement markings comprising of at least one laser comprising of a laser head which produces a laser beam that is directed to the pavement marking, a lens through which the laser beam passes, and a laser box containing the laser head and the lens. The system also comprises of a water cool-er chiller connected to the laser box to regulate the temperature of the laser within normal operating conditions; optionally, a fume extractor to remove debris that may be generated by the laser beam passing over the pavement marking; a power source connected to the laser; a sensor to acquire images of the pavement marking (e.g., before and/or after passing the laser across the pavement marking); a computing device comprising a processor and a memory that communicates with the laser, the chiller, and the power source; and machine-readable instructions stored in the memory that, when executed by the processor, cause the computing device to perform the method of any of embodiments 9-15 or other methods described herein.

Embodiment 17 comprises of a system as set forth in embodiment 16, further comprising at least one air knife disposed in the laser box, the at least one air knife positioned to cut across a path of the laser beam to protect the lens from debris from the laser beam passing over the pavement marking, the at least one air knife being powered by an air compressor.

Embodiment 18 comprises of a system as set forth in embodiment 16, wherein the laser is a pulsed laser.

Embodiment 19 comprises of a system as set forth in embodiment 16, wherein the sensor is a photographic camera.

Embodiment 20 comprises of a system as set forth in embodiment 16, wherein the sensor is a video camera.

Embodiment 21 comprises of a system as set forth in embodiment 16, wherein the power source is a Honda EU7000ISNAN 7000-Watt 120/240-Volt Inverter Generator.

Embodiment 22 comprises of a system as set forth in embodiment 16, further comprising at least one mirror disposed between the laser scan head and the lens.

Embodiment 23 is a non-transitory, computer-readable medium, comprising machine-readable instructions that, when executed by a processor, cause a computing device to perform the method of any of embodiments 9-15.

Embodiment 24 is a system for removing pavement markings comprising of a vehicle, and a laser system connected to the vehicle and directed toward a pavement marking, the laser system comprising of a laser beam that is passed over the pavement marking, a water-cooler chiller connected to the laser to regulate the temperature of the laser within operating conditions, and a power source. The system also comprises of a sensor that acquires images or video during and/or after passing the laser beam over the pavement marking, a computing device comprising of a processor and a memory that communicates with the laser, the chiller, and the power source and optionally the vehicle, and machine-readable instructions stored in the memory that, when executed by the processor, cause the computing device to perform the method of any of embodiments 9-15.

Embodiment 25 comprises of a system as set forth in embodiment 24, further comprising at least one air knife disposed in the laser box, the at least one air knife positioned to cut across a path of the laser beam to protect the lens from debris after the laser beam passes over the pavement marking, the at least one air knife being powered by an air compressor.

Embodiment 26 comprises of a system as set forth in embodiment 24, wherein the laser is a pulsed laser.

Embodiment 27 comprises of a system as set forth in embodiment 24, wherein the sensor is a photographic camera.

Embodiment 28 comprises of a system as set forth in embodiment 24, wherein the sensor is a video camera.

Embodiment 29 comprises of a system as set forth in embodiment 24, wherein the power source is a Honda EU7000ISNAN 7000-Watt 120/240-Volt Inverter Generator.

Embodiment 30 comprises of a system as set forth in embodiment 24, further comprising at least one mirror disposed between the laser scan head and the lens.

1. A method, comprising:
aligning a vehicle with a type of pavement marking on a type of pavement, the vehicle having a laser system;
aiming the laser system at the type of pavement marking;
detecting the type of pavement marking using a sensor;
detecting the type of pavement using the sensor;
setting a plurality of laser parameters based at least in part on detection of the type of pavement marking and detection of the type of pavement;
activating the laser system to produce a laser beam; and
passing the laser beam over the type of pavement marking in a scan direction. at least one of:

2. The method of claim 1, wherein the plurality of laser parameters includes a laser power;
a laser wavelength;
a laser fluence;
a pulse frequency;
a pulse width;
a velocity; and
a fill pitch.

3. The method of claim 1, further comprising:
changing the scan direction to a second scan direction; and
passing the laser beam over the type of pavement marking in the second scan direction.

4. The method of claim 1, further comprising:
blocking the laser beam from exiting the laser system;
determining a residual mark of a plurality of residual marks exists; and
in response to determining a residual mark, passing the laser over the residual mark.

5. The method of claim 4, further comprising:
blocking the laser beam from exiting the laser system;
determining the type of pavement is free of residual marks; and
in response to determining the type of pavement is free of residual marks, blocking the laser beam from exiting the laser system.

6. The method of claim 1, further comprising removing a plurality of glass beads from the type of pavement marking prior to activating the laser.

7. The method of claim 1, further comprising:
blocking the laser beam from exiting the laser system;
detecting a second type of pavement marking;
adapting the plurality of laser parameters, based at least in part on the second type of pavement marking and the type of pavement;
unblocking the laser beam; and
passing the laser over the second type of pavement marking in a scan direction.

8. The method of claim 7, further comprising:
changing the scan direction to a second scan direction; and
passing the laser over the second type of pavement marking in the second scan direction.

9. A method, comprising:
receiving, by a laser control application, a vehicle aligned indication that a vehicle has been aligned with a type of pavement marking on a type of pavement;
sending, by the laser control application, a request to a laser system to aim a laser beam at the type of pavement marking;
receiving, by the laser control application, a pavement type indication from a sensor;
receiving, by the laser control application, a pavement marking type indication from the sensor;
determining, by the laser control application, a plurality of laser parameters based at least in part on the pavement type indication and the pavement marking type indication;
sending, by the laser control application, the plurality of laser parameters to the laser system;
sending, by the laser control application, an initiation request to the laser system; and
sending, by the laser control application, a movement request to the laser system to pass the laser beam over the type of pavement marking in a scan direction.

10. The method of claim 9, wherein the plurality of laser parameters includes at least one of:
a laser power;
a laser wavelength;
a laser fluence;
a pulse frequency;
a pulse width;
a velocity; and
a fill pitch.

11. The method of claim 9, further comprising:
sending, by the laser control application, a request to the laser system to change the scan direction to a second scan direction; and
sending, by the laser control application, a movement request to the laser system to pass the laser beam over the type of pavement marking in the second scan direction.

12. The method of claim 9, further comprising:
sending, by the laser control application, a request to the laser system to block the laser beam from exiting the laser system. receiving, from the sensor, a determination of a residual mark of a plurality of residual marks; and
in response to receiving a determination of a residual mark, sending, by the laser control application, a request to the laser system to unblock the laser beam; and
sending, by the laser control application, a movement request to the laser system to pass the laser beam over the residual mark.

13. The method of claim 12, further comprising:
sending, by the laser control application, a request to the laser system to block the laser beam from exiting the laser system,
receiving, from the sensor, a determination that the type of pavement is free of residual marks; and
in response to receiving a determination that the type of pavement is free of residual marks, sending, by the laser control application, a request to a user to find a next pavement marking.

14. The method of claim 9, further comprising:
sending, by the laser control application, a request to the laser system to block the laser beam from exiting the laser system;
receiving, by the laser control application, a second pavement marking type indication from the sensor;
determining, by the laser control application, a plurality of laser parameters based at least in part on the second pavement marking type indication;
sending, by the laser control application, a request to the laser system to unblock the laser beam; and
sending, by the laser control application, a movement request to the laser system to pass the laser beam over the type of pavement marking in a scan direction.

15. The method of claim 14, further comprising:
sending, by the laser control application, a request to the laser system to change the scan direction to a second scan direction; and
sending, by the laser control application, a movement request to the laser system to pass the laser beam over the type of pavement marking in the second scan direction.

16. A system configured to remove pavement markings, comprising:
at least one laser comprising
a laser head which produces a laser beam, wherein system is configured to direct the laser beam at the pavement marking,
a lens through which the laser beam passes, and
a laser box containing the laser head and the lens;
a water-cooler chiller connected to the laser box configured to regulate the temperature of the laser;
optionally, a fume extractor in communication with an area adjacent the pavement marking to remove fumes upon passing the laser over the pavement markings;
a power source connected to the laser;
a sensor, wherein the sensor is configured to capture an image of the pavement marking;
a computing device comprising a processor and a memory, wherein the computing device is in communication with the laser, the water cooler, the power source, and the sensor; and
machine-readable instructions stored in the memory that, when executed by the processor, cause the computing device to perform the method of any one of claims 1-15.

17. The system of claim 16, further comprising at least one air knife disposed in the laser box, the at least one air knife positioned to cut across a path of the laser beam to protect the lens from debris when the laser is passed over the pavement marking, the at least one air knife being powered by an air compressor.

18. The system of claim 16, wherein the laser is a pulsed laser.

19. The system of claim 16, wherein the sensor is a photographic camera or a video camera.

20. The system of claim 16, further comprising a vehicle, wherein the laser, the water cooler, the power source, and the sensor are disposed on the vehicle.
